(19) United States
(12) Patent Application Publication
(10) Pub. No.: US 2025/0177860 A1
(43) Pub. Date: Jun. 5, 2025

(54) NON-TRANSITORY COMPUTER READABLE MEDIUM, INFORMATION PROCESSING METHOD, AND GAME APPARATUS

(71) Applicant: CYGAMES, INC., Tokyo (JP)

(72) Inventors: Gen Takubo, Tokyo (JP); Michiaki Sakaguchi, Tokyo (JP); Masatoshi Nishimura, Tokyo (JP); Yusuke Kawazoe, Tokyo (JP)

(73) Assignee: CYGAMES, INC., Tokyo (JP)

(21) Appl. No.: 19/049,684

(22) Filed: Feb. 10, 2025

Related U.S. Application Data
(63) Continuation of application No. PCT/JP2023/027241, filed on Jul. 25, 2023.

(30) Foreign Application Priority Data
Aug. 12, 2022 (JP) 2022-129123

(51) Int. Cl. A63F 13/533; A63F 13/69; A63F 13/79

(52) U.S. Cl. CPC A63F 13/533; A63F 13/69; A63F 13/79; A63F 2300/638

(57) ABSTRACT

A non-transitory computer readable medium stores a program causing a computer to execute processing of giving a reward to a player based on a first predetermined task being executed within a predetermined time period, the first predetermined task being a task related to a piece of content preset among a plurality of pieces of content provided; processing of limiting the number of times a second predetermined task is executable in the predetermined time period, the second predetermined task being a task related to a piece of content preset among the plurality of pieces of content provided; processing of setting any of a plurality of predetermined tasks including the first predetermined task and the second predetermined task as a notification target based on a player operation; and processing of displaying a list display screen displaying the any of the plurality of predetermined tasks set as the notification target.

### CROSS REFERENCE TO RELATED APPLICATIONS

This application is a continuation application of International Application No. PCT/JP2023/027241, filed on Jul. 25, 2023, which claims priority to Japanese Patent Application No. 2022-129123, filed on Aug. 12, 2022, the entire contents of which are incorporated by reference herein.

### BACKGROUND ART

### Technical Field

The present invention relates to an information processing program, an information processing method, and a game apparatus.

Patent Literature 1 discloses a game in which so-called daily missions are set for a player. The player can obtain a predetermined bonus by completing the daily missions. The right to be able to obtain a bonus by completing the daily missions is reset every day at the same time. Thus, the player can repeatedly obtain the bonus by completing the daily missions every day. In this manner, the daily missions motivate the player to play the game.

### CITATION LIST

### Patent Literature

Patent Literature 1: JP 7076614 B

### SUMMARY OF INVENTION

### Technical Problem

In addition to the daily missions, in-game tasks may be present that are recommended to be executed in order to efficiently advance through the game. If a large number of daily missions are set or a large number of in-game tasks are present that are recommended to be executed in order to efficiently advance through the game, player operations become complex and the player may become less motivated to play the game.

An object of the present invention is to provide an information processing program, and information processing method, and a game apparatus that can suppress a player to become less motivated to play the game.

### Solution to Problem

To solve the problem described above, an information processing program causes a computer to execute: processing of giving a reward to a player based on a first predetermined task being executed within a predetermined time period, the first predetermined task being a task related to a piece of content preset among a plurality of pieces of content provided; processing of limiting the number of times a second predetermined task is executable within the predetermined time period, the second predetermined task being a task related to a piece of content preset among the plurality of pieces of content provided; processing of setting any of a plurality of predetermined tasks including the first predetermined task and the second predetermined task as a notification target, based on a player operation; and processing of displaying a list display screen displaying the any of the plurality of predetermined tasks designated as the notification target.

The information processing program nay further cause the computer to execute processing of displaying an execution screen for executing a predetermined task of the plurality of predetermined tasks, based on a player operation on the displayed list display screen.

The information processing program may further cause the computer to execute processing of omitting display of the execution n screen and collectively executing a plurality of the predetermined tasks, based on a player operation on the displayed list display screen.

To solve the problem described above, an information processing method executed by one or more computers includes: processing, by the one or more computers, of giving a reward to a player based on a first predetermined task being executed within a predetermined time period, the first predetermined task being a task related to a piece of content preset among a plurality of pieces of content provided; processing, by the one or more computers, of limiting the number of times a second predetermined task is executable within the predetermined time period, the second predetermined task being a task related to a piece of content preset among the plurality of pieces of content provided; processing, by the one or more computers, of setting any of a plurality of predetermined tasks including the first predetermined task and the second predetermined task as a notification target, based on a player operation; and processing, by the one or more computers, of displaying a list display screen displaying the any of the plurality of predetermined tasks designated as the notification target.

To solve the problem described above, a game apparatus includes one or more computers, wherein the one or more computers execute: processing of giving a reward to a player based on a first predetermined task being executed within a predetermined time period, the first predetermined task being a task related to a piece of content preset among a plurality of pieces of content provided; processing of limiting the number of times a second predetermined task is executable within the predetermined time period, the second predetermined task being a task related to a piece of content preset among the plurality of pieces of content provided; processing of setting any of a plurality of predetermined tasks including the first predetermined task and the second predetermined task as a notification target, based on a player operation; and processing of displaying a list display screen displaying the any of the plurality of predetermined tasks designated as the notification target.

### Effects of Disclosure

According to the present invention, the risk of a player to become less motivated to play the game can be suppressed.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3 is a diagram for describing an example of a home screen.

FIG. 4A is a diagram for describing an example of an ally character confirmation screen. FIG. 4B is a diagram for describing an example of a story screen. FIG. 4C is a diagram for describing an example of a quest screen.

FIG. 5A is a diagram for describing an example of a main quest screen. FIG. 5B is a diagram for describing an example of a main quest selection screen. FIG. 5C is a diagram for describing an example of a party selection screen.

FIG. 6A is a diagram for describing an example of a battle game screen. FIG. 6B is a diagram for describing an example of a first result screen. FIG. 6C is a diagram for describing an example of a second result screen.

FIG. 7 is a diagram for describing an example of a gacha screen.

FIG. 8A is a diagram for describing an example of a normal shop screen. FIG. 8B is a diagram for describing an example of a bonus shop screen.

FIG. 9A is a first diagram for describing an example of a first currency purchase screen. FIG. 9B is a second diagram for describing an example of the first currency purchase screen.

FIG. 10A is a diagram for describing an example of a daily missions screen. FIG. 10B is a diagram for describing an example of a reward reception screen.

FIG. 11A is a first diagram for describing an example of a schedule screen. FIG. 11B is a diagram for describing an example of a notification setting screen.

FIG. 12 is a diagram for describing an example of a notification setting content display.

FIG. 13A is a diagram for describing an example of a first execution system result screen. FIG. 13B is a diagram for describing an example of a second execution system result screen.

FIG. 14A is a diagram for describing an example of a third execution system result screen. FIG. 14B is a second diagram for describing an example of the schedule screen.

FIG. 15 is a diagram for describing a configuration of a memory in the player terminal and a function thereof as a computer.

FIG. 16 is a diagram for describing a configuration of a memory in the server and a function thereof as a computer.

FIG. 17 is a sequence diagram for describing basic processing of the player terminal and the server.

FIG. 18 is a flowchart for describing notification target setting processing in the player terminal.

FIG. 19 is a flowchart for describing content automatic execution associated processing in the player terminal.

FIG. 20 is a flowchart for describing automatic execution processing in the player terminal.

### DESCRIPTION OF EMBODIMENTS

Hereinafter, an aspect of an embodiment of the present invention will be described in detail with reference to the accompanying drawings. Dimensions, materials, specific numerical values, and the like described in the embodiment are merely examples for facilitating understanding and do not limit the present invention unless otherwise specified. In the present description and the drawings, elements having substantially the same function and configuration are denoted by the same reference numerals, and redundant description thereof will be omitted, and elements not directly relating to the present invention will not be illustrated.

### Overall Configuration of Information Processing System S

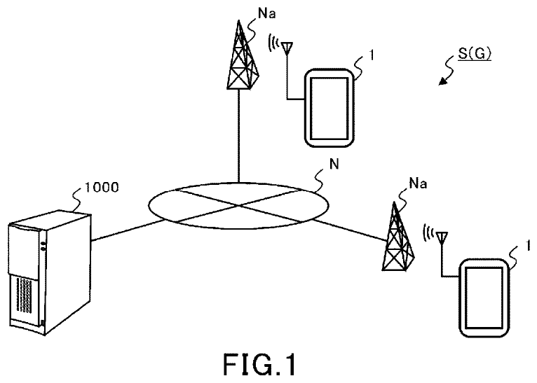

FIG. 1 is an explanatory diagram illustrating a schematic configuration of an information processing system S. The information processing system S is a so-called client-server system including a player terminal 1 functioning as a client, that is, a game terminal; a server 1000; and a communication network N including a communication base station Na.

In the information processing system S of the present embodiment, the player terminal 1 and the server 1000 function as a game apparatus G. Each of the player terminal 1 and the server 1000 has a role of controlling the progress of a game, and the game can progress via cooperation between the player terminal 1 and the server 1000.

The player terminal 1 can establish communication with the server 1000 via the communication network N. The player terminal 1 includes various electronic devices capable of establishing a wireless or wired communication connection with the server 1000. Examples of the player terminal 1 include a smartphone, a mobile phone, a tablet device, a personal computer, and a game console, and the like. In the present embodiment, a case where a smartphone is used as the player terminal 1 will be described.

The server 1000 is communicatively connected to a plurality of the player terminals 1. The server 1000 accumulates various types of information for each player who plays the game. In addition, the server 1000 performs processing such as updating the accumulated information and downloading images and various types of information to the player terminal 1 based on an operation input from the player terminal 1.

The communication base station Na is connected to the communication network N and wirelessly exchanges information with the player terminal 1. The communication network N is constituted by a cellular network, an Internet network, a local area network (LAN), a dedicated line, or the like, and realizes a wireless or wired communication connection between the player terminal 1 and the server 1000.

### Hardware Configuration of Player Terminal 1 and Server 1000

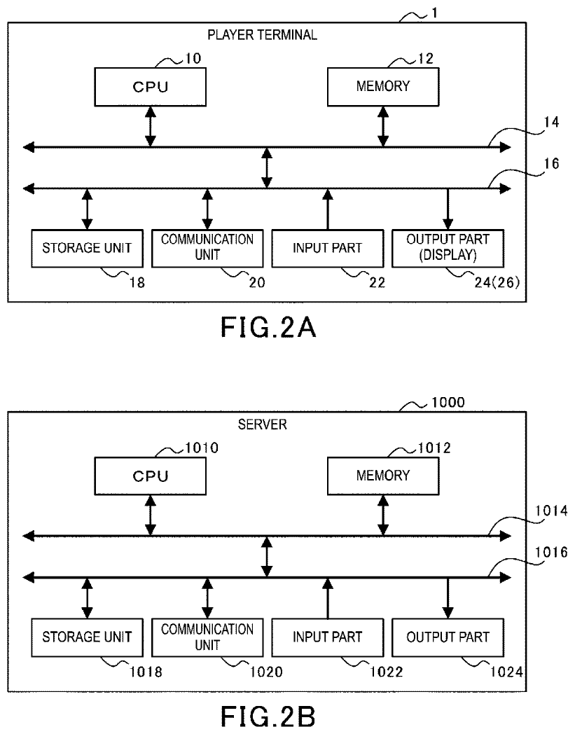

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 CPU a memory 1012, a bus 1014, an includes a 1010, input/output interface 1016, a storage unit 1018, a communication unit 1020, an input part 1022, and an output part 1024.

The configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 1000 will be omitted.

The CPU 10 operates a program stored in the memory 12 to control the progress of the game. The memory 12 is constituted by a read-only memory (ROM) or a random-access memory (RAM) and stores programs and various types of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various types of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various types of data and programs with the server 1000 via the communication network N. In the player terminal 1, programs or the like received from the server 1000 are stored in the memory 12 or the storage unit 18.

The input part 22 includes, for example, a touch panel, a button, a keyboard, a mouse, a four-direction key, an analog controller, and the like for inputting player operations (receiving operations). Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects speech from the player. That is, the input part 22 includes various apparatuses capable of input that can identify the intention of the player.

The output part 24 includes a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

### Game Content

Next, content of a game provided by the information processing system S (game apparatus G) of the present embodiment will be described using an example. In the present embodiment, a so-called battle game is provided in which one or more ally characters form a party and fight against an enemy character. In the game of the present embodiment, a plurality of ally characters are provided from the management side of the game to the player. For example, the player can own a plurality of ally characters obtained through a lottery called a gacha or distributed from the management side.

In the battle game, the player can select one or more ally characters owned by the player to form a party. The player can play the battle game using the formed party. The object of the battle game is for the ally characters in the party to obtain rewards by defeating (clearing) enemy characters. Various types of battle games with different enemy characters and different difficulty levels can be played by the player.

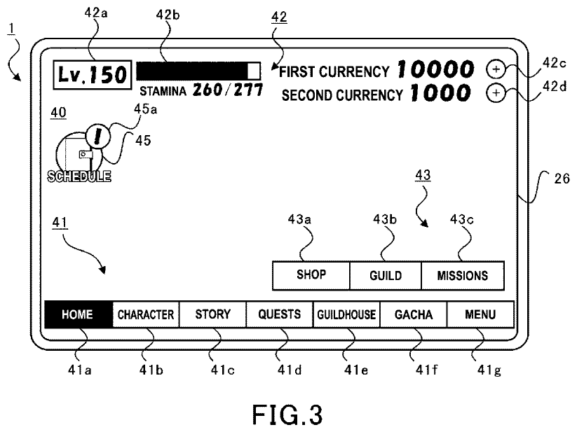

FIG. 3 is a diagram illustrating an example of a home screen 40. The home screen 40 illustrated in FIG. 3 is a screen that is first displayed after the player performs a tap operation on the display 26 on a title screen (not illustrated) (that is, after the game is started).

As illustrated in FIG. 3, on the home screen 40, a menu bar 41 is displayed at a lower portion of the display 26. The menu bar 41 is displayed at the lower portion of the display 26 on normal screens other than the title screen (not illustrated).

The menu bar 41 is provided with a plurality of operation portions that can be operated (tapped) by the player. The menu bar 41 is provided with a home screen selection operation portion 41a denoted by “Home”. The menu bar 41 is provided with an ally character confirmation screen selection operation portion 41b denoted by “Characters”. The menu bar 41 is provided with a story screen selection operation portion 41c denoted by “Story”. The menu bar 41 is provided with a quest screen selection operation portion 41d denoted by “Quests”. The menu bar 41 is provided with a guildhouse screen selection operation portion 41e denoted by “Guildhouse”. The menu bar 41 is provided with a gacha screen selection operation portion 41f denoted by “Gacha”. The menu bar 41 is provided with a menu screen selection operation portion 41g denoted by “Menu”. In the menu bar 41, the portion corresponding to the screen being operation displayed is highlighted so that each screen on the display 26 can be identified.

When the home screen selection operation portion 41a is operated (tapped) by the player, the home screen 40 illustrated in FIG. 3 is displayed on the display 26.

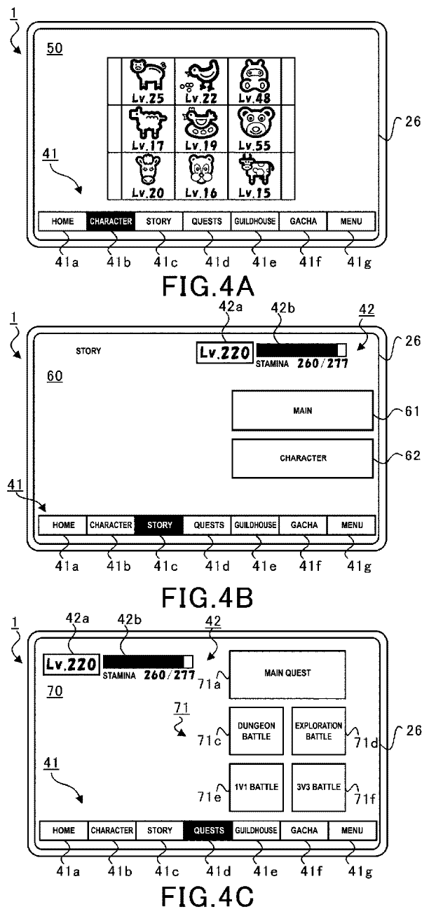

When the ally character confirmation screen selection operation portion 41b is operated (tapped) by the player, an ally character confirmation screen 50 (FIG. 4A described below) is displayed on the display 26.

When the story screen selection operation portion 41c is operated (tapped) by the player, a story screen 60 (FIG. 4B described below) is displayed on the display 26.

When the quest screen selection operation portion 41d is operated (tapped) by the player, a quest screen 70 (FIG. 4C described below) is displayed on the display 26.

When the guildhouse screen selection operation portion 41e is operated (tapped) by the player, a guildhouse screen (not illustrated) is displayed on the display 26. Although described below in detail, a game space that is the player's own room is displayed on a guildhouse screen (not illustrated).

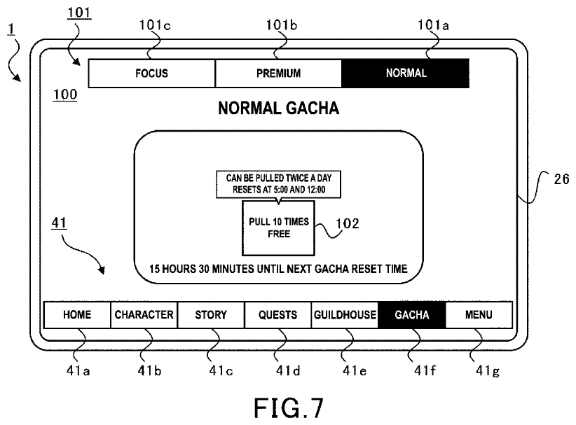

When the gacha screen selection operation portion 41f is operated (tapped) by the player, a gacha screen 100 (FIG. 7 described below) is displayed on the display 26. Although described below in detail, on the gacha screen 100, it is possible to perform a gacha lottery in which an ally character or item can be obtained through a lottery.

When the menu screen selection operation portion 41g is operated (tapped) by the player, a menu screen (not illustrated) is displayed on the display 26. On the menu screen, game settings and various types of information can be checked.

Also, as illustrated in FIG. 3, a header display area 42 is provided in an upper portion of the home screen 40. At least a part of player information associated with a player ID is displayed in the header display area 42.

For example, as illustrated in FIG. 3, level information 42a indicating the player level and a stamina display bar 42b indicating the stamina of the player are displayed in the header display area 42. Further, as illustrated in FIG. 3, the stamina of the player is displayed by a numerical value at a lower portion of the stamina display bar 42b.

The player information includes a player ID, ally character identification information (hereinafter referred to as an ally character ID) for identifying an ally character owned by the player, the level information 42a, stamina information displayed on the stamina display bar 42b, story progress information to be described below, battle game clear information, in-game currency information indicating the amount of in-game currency owned by the player, and item information indicating the type and amount of items owned by the player.

The stamina is a parameter necessary for the player to play the battle game. In the present embodiment, a plurality of types of battle games are provided, and a stamina consumption value required to play, a maximum number of play times within a preset time period (for example, from 5:00 to 4:59 the next day), and the like are set for each battle game. When a battle game in which the stamina consumption value necessary for play is set is played, a player consumes stamina to play the battle game. Thus, when the stamina is insufficient, the player cannot play the battle game.

Although detailed description is omitted, when the player wins in the battle game, the player can obtain a predetermined value as player experience. Each time the player experience reaches a certain value, the player level increases. For player levels, an upper limit value for stamina is set. As the player level increases, the upper limit value for stamina increases.

Stamina is recovered by a predetermined value (for example, one point) at regular time intervals (for example, five minutes) within the range of the upper limit value. In the stamina display bar 42b, the current remaining amount of stamina is displayed so as to be visually recognizable with respect to the upper limit value of stamina. The numerical value of stamina displayed at the lower portion of the stamina display bar 42b is “260/277” in the example of FIG. 3, where “277” is the upper limit value of stamina displayed as the denominator, and “260” is the current stamina of the player displayed as the numerator.

In the present embodiment, a part of the battle game includes a battle game that can be played without consuming stamina. As a battle game that can be played without consuming stamina, in the present embodiment, “Dungeon Battle”, “Exploration Battle”, “1V1 battle”, and “3V3 battle”, which will be described below, are provided.

For each such battle game, a maximum number of play times or the like within a preset time period (for example, from 5:00 to 4:59 the next day) is set. Thus, in a case where the player has already played the maximum number of play times within a preset time period (for example, from 5:00 to 4:59 the next day), the player cannot play these battle games.

The owned amount of first currency and second currency associated with a player ID is displayed on the header display area 42. The first currency and the second currency are currencies usable only in the game.

For example, when a battle game is cleared, a predetermined amount of the first currency can be obtained according to the cleared battle game. Further, the second currency can be obtained free of charge or for a fee.

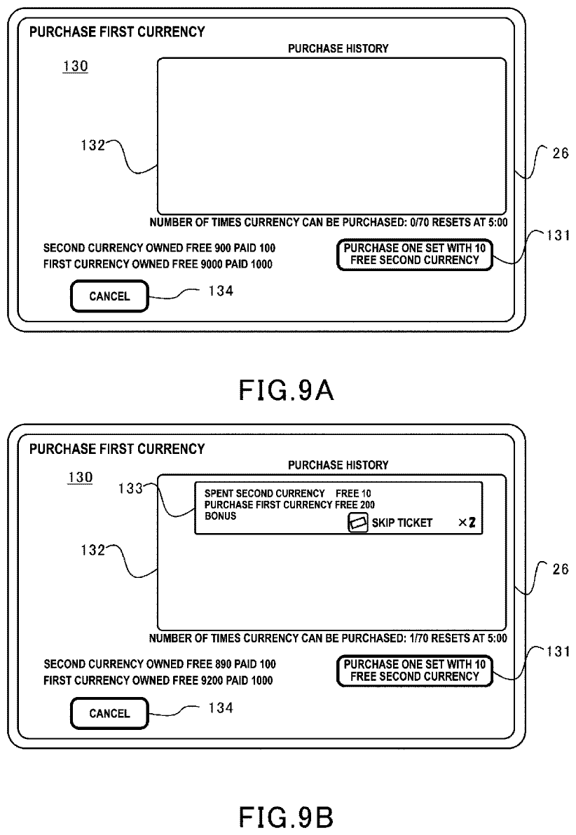

As illustrated in FIG. 3, a first currency purchase screen operation portion 42c is displayed on a right side of the display of the owned amount of the first currency on the display 26. When the player operates (taps) the first currency purchase screen operation portion 42c, a first currency purchase screen 130 (FIG. 9A) described below is displayed on the display 26. Although described below in detail, the player can obtain (purchase) the first currency by spending the second currency on the first currency purchase screen 130.

As illustrated in FIG. 3, a second currency purchase screen operation portion 42d is displayed on a right side of the display of the owned amount of the second currency on the display 26. When the player operates (taps) the second currency purchase screen operation portion 42d, a second currency purchase screen (not illustrated) is displayed on the display 26. The player can obtain (purchase) the second currency for a fee on the second currency purchase screen (not illustrated).

Further, as illustrated in FIG. 3, a home menu 43 is displayed in an upper portion of the menu bar 41 of the home screen 40. The home menu 43 is provided with a shop screen selection operation portion 43a denoted by “Shop”, a guild screen selection operation portion 43b denoted by “Guild”, and a mission screen selection operation portion 43c denoted by “Missions”.

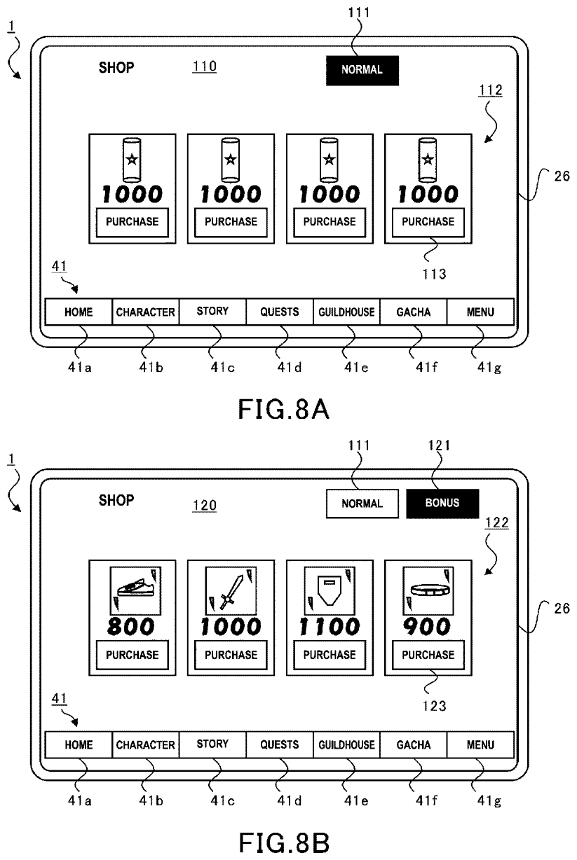

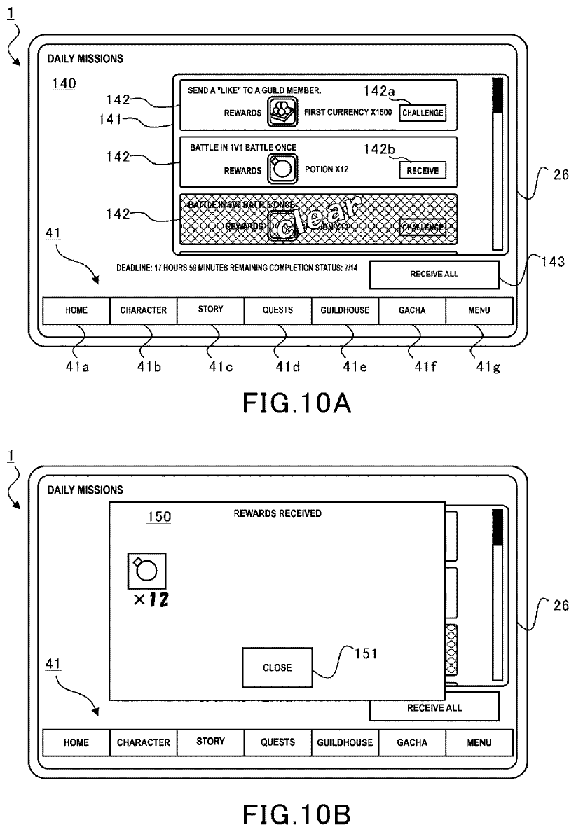

When the shop screen selection operation portion 43a is operated (tapped), a normal shop screen 110 (FIG. 8A described below) where items can be purchased is displayed. When the guild screen selection operation portion 43b is operated (tapped), a guild screen (not illustrated) is displayed on the display 26. Further, when the mission screen selection operation portion 43c is operated (tapped), a daily missions screen 140 (FIG. 10A described below) is displayed on the display 26.

Further, as illustrated in FIG. 3, a schedule screen selection operation portion 45 denoted by “Schedule” is displayed on a left side of the home screen 40. As illustrated in FIG. 3, an icon representing a notebook is displayed on the schedule screen selection operation portion 45.

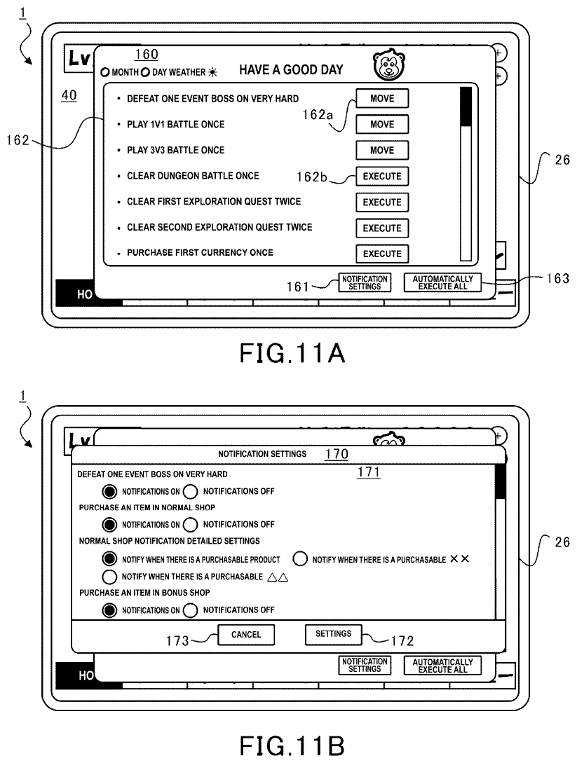

When the player operates (taps) the schedule screen selection operation portion 45, the schedule screen selection operation portion 45 is hidden on the display 26, and a schedule screen 160 (FIG. 11A) described below is displayed on the display 26. On the schedule screen 160, an automatic execution function and a notification function, which will be described below in detail, can be used.

As illustrated in FIG. 3, in a case where a predetermined condition set in advance is satisfied, an identification display 45a represented by “!” is displayed on the schedule screen selection operation portion 45. Specifically, in a case where at least one of a move operation portion 162a or an execute operation portion 162b is displayed on a notification target display portion 162 (FIG. 11A) described below, a predetermined condition set in advance is satisfied and the identification display 45a is displayed. FIG. 3 illustrates a case where “!” is displayed as the identification display 45a. However, the content of the identification display 45a is not limited thereto. For example, a number may be displayed.

FIG. 4A is a diagram for describing an example of the ally character confirmation screen 50. When the ally character confirmation screen selection operation portion 41b of the menu bar 41 is operated (tapped) by the player, the ally character confirmation screen 50 illustrated in FIG. 4A is displayed on the display 26. On the ally character confirmation screen 50, all images of the ally characters corresponding to the ally character IDs associated with the player ID are displayed.

In other words, all the ally characters possessed player are displayed on the ally character by the confirmation screen 50. Note that a different ally character ID is assigned to each ally character. When the player obtains a new ally character via, for example, a gacha lottery or the like, the ally character ID of the obtained ally character is associated with the player ID of the player.

Stars (rank), experience, and level are stored in association with the ally character. The experience increases when a player wins in a battle game described below or when a predetermined item is used. The level is set corresponding to the experience, and the level increases each time the experience reaches a predetermined value. An upper limit value of the level is set for each ally character, and the level increases only within a range up to the upper limit value.

In addition, base values of the power of the ally character such as life points, attack power, and defense power are set for the ally character based on the stars (rank) and the level. The player can advantageously progress through the battle game as the power of the ally character increases. Each base value set for the ally character increases as the stars (rank) increase and as the level increases.

On the ally character confirmation screen 50, it is possible to equip (set) the ally character with equipment such as weapons and armors. An additional value for attack power, defense power, and/or the like is set for each piece of equipment. When the equipment is equipped, the additional value of each piece of equipment is added to the base values, and the power of the ally character can be enhanced. The information relating to equipment such as weapons and armor is also associated with the ally character ID and is configured as a part of the player information.

FIG. 4B is a diagram for describing an example of the story screen 60. When the story screen selection operation portion 41c of the menu bar 41 is operated (tapped) by the player, the story screen 60 illustrated in FIG. 4B is displayed on the display 26. As illustrated in FIG. 4B, the story screen 60 displays the menu bar 41, the header display area 42, a main story selection operation portion 61, and a character story selection operation portion 62.

When the main story selection operation portion 61 in the story screen 60 is operated (tapped) by the player, a main story screen (not illustrated) is displayed on the display 26. On the main story screen, a plurality of main stories unlock in accordance with the degree of progress of “Main Quest” described below are displayed. When a new main story is unlocked as a result of the player proceeding with “Main Quest” described below, the player can view the unlocked main story from a main story screen (not illustrated).

When the character story selection operation portion 62 in the story screen 60 illustrated in FIG. 4A is operated (tapped), a character story (not illustrated) unlocked in accordance with a friendship level of the ally character is displayed on the display 26.

Note that the friendship level of the ally character increases when the ally character wins a battle game described below or when a predetermined item is used. Each time the friendship level reaches a predetermined value, the friendship level rank increases. Note that an upper limit value of the friendship level rank is set for the ally character, and the rank increases only in a range up to the upper limit value. When the friendship level of the ally character increases to the upper limit value, all the character stories for the ally character are unlocked. When a new character story is unlocked, the player can view the unlocked character story from a character story screen (not illustrated).

FIG. 4C is a diagram for describing an example of the quest screen 70. When the quest screen selection operation portion 41d of the menu bar 41 is operated (tapped) by the player, the quest screen 70 illustrated in FIG. 4C is displayed on the display 26. On the quest screen 70, the menu bar 41, the header display area 42, and a plurality of game type selection operation portions 71 displaying the game types provided are displayed. Here, five types of games are provided, and six game type selection operation portions 71 are displayed.

As illustrated in FIG. 4C, the game type selection operation portion 71 includes a main quest selection operation portion 71a denoted by “Main Quest”. The game type selection operation portion 71 includes a dungeon battle selection operation portion 71c denoted by “Dungeon Battle”. The game type selection operation portion 71 includes an exploration battle selection operation portion 71d denoted by “Exploration Battle”. The game type selection operation portion 71 includes 1V1 battle selection operation portion 71e denoted by “1V1 Battle”. The game type selection operation portion 71 includes a 3V3 battle selection operation portion 71f denoted by “3V3 Battle”.

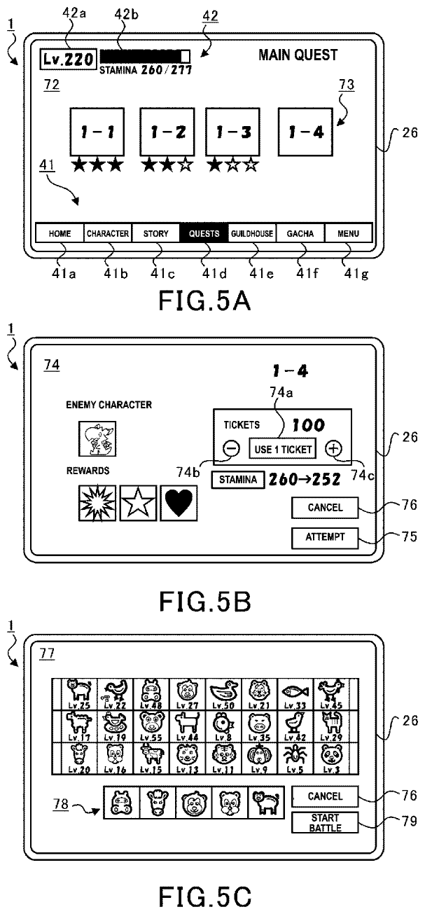

When the main quest selection operation portion 71a is operated (tapped) by the player, a main quest screen 72 (FIG. 5A described below) is displayed on the display 26.

When the dungeon battle selection operation portion 71c is operated (tapped) by the player, a dungeon battle screen (not illustrated) is displayed on the display 26.

When the exploration battle selection operation portion 71d is operated (tapped) by the player, an exploration battle screen (not illustrated) is displayed on the display 26.

Also, when the 1V1 battle selection operation portion 71e is operated (tapped), a 1V1 battle screen (not illustrated) is displayed on the display 26.

When the 3V3 battle selection operation portion 71f is (operated) tapped, a 3V3 battle screen (not illustrated) is displayed on the display 26.

Depending on the game type, an unlock condition may be set. Examples of unlock conditions include the player level being equal to or greater than a predetermined value or another predetermined game being completed (cleared). In addition, each game type includes a plurality of games (stages or rounds). An unlock condition is set for each of these games. When the unlock condition is satisfied, game unlock information included in the player information is updated.

In the player terminal 1, it is determined whether the game is unlocked based on the game unlock information, and only the game type selection operation portion 71 of the game satisfying the unlock condition may receive a player operation (tap). Thus, the player can play only games satisfying the unlock condition.

When the main quest selection operation portion 71a on the quest screen 70 illustrated in FIG. 4B is operated (tapped) by the player, a main quest screen 72 (FIG. 5A described below) for executing “Main Quest” is displayed on the display 26.

FIG. 5A is a diagram for describing an example of the main quest screen 72. FIG. 5B is a diagram for describing an example of a main quest selection screen 74. FIG. 5C is a diagram for describing an example of a party selection screen 77.

On the main quest screen 72, the menu bar 41, the header display area 42, and a main quest operation portion 73 for selecting a plurality of battle games (stages) belonging to the main quest are displayed.

Clear information of each battle game is also displayed in the main quest operation portion 73. The clear information is indicated using three stars, for example. In a battle game belonging to the main quest, when the battle game is completed (cleared), stars are obtained in accordance with the number of ally characters whose life points are 0 when the battle game is completed (cleared). For example, when there are no ally characters with 0 life points, three stars are obtained. For example, when there is one ally character with 0 life points, two stars are obtained. For example, when there are two or more ally characters with 0 life points, one star is obtained.

In the example of FIG. 5A, three stars have been obtained in the battle game “1-1”, two stars have been obtained in the battle game “1-2”, and one star has been obtained in the battle game “1-3”. In addition, for the battle game “1-4”, no stars have been obtained, notifying that the battle game has not been completed (cleared).

In the main quest, completion (clearing) of the previous battle game is set as an unlock condition. For example, in the example of FIG. 5A, the battle game “1-3” is completed (cleared), unlocking the battle game “1-4”, but the subsequent battle games (“1-5” and subsequent battle games (not illustrated)) are not unlocked.

In the main quest screen 72, for example, when the main quest operation portion 73 of the battle game “1-4” is operated (tapped), the main quest selection screen 74 illustrated in FIG. 5B is displayed on the display 26. On the main quest selection screen 74, an enemy character appearing in the battle game and an item (reward) obtainable in the battle game are displayed.

In addition, on the main quest selection screen 74, stamina after consumption in a case where stamina is consumed to attempt the battle game is displayed. Here, a change in the current stamina from 260 to 252 after consumption is displayed.

In addition, on the main quest selection screen 74, an attempt operation portion 75 denoted by “Attempt” for attempting the battle game and a cancel operation portion 76 denoted by “Cancel” for canceling the processing corresponding to the currently displayed screen are displayed.

When the cancel operation portion 76 is operated (tapped), the main quest screen 72 illustrated in FIG. 5A is displayed on the display 26 and the attempt of the selected battle game “1-4” is canceled.

On the other hand, when the attempt operation portion 75 is operated (tapped), the party selection screen 77 illustrated in FIG. 5C is displayed on the display 26. On the party selection screen 77, all the ally characters possessed by the player are displayed and, below that, a selected ally character display area 78 for displaying the selected ally character is displayed.

In addition, on the party selection screen 77, the cancel operation portion 76 and a battle start operation portion 79 denoted by “Start battle” are displayed.

When the player operates (taps) the displayed ally character on the party selection screen 77, the operated (tapped) ally character is displayed in the selected ally character display area 78. That is, here, an ally character ID to be used in the battle game (to determine a party) is selected from among a plurality of ally character IDs associated with the player ID. When the player selects a plurality of ally characters, a party is formed. In the party formation, the same ally character cannot be set more than once.

When the party formation is completed and the battle start operation portion 79 is operated (tapped), the battle game is started and a battle game screen 80 is displayed on the display 26.

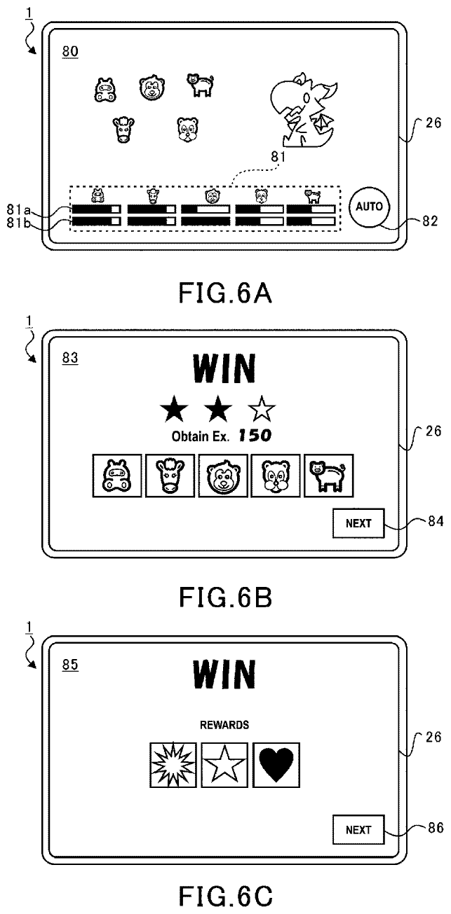

FIG. 6A is a diagram for describing an example of the battle game screen 80. FIG. 6B is a diagram for describing an example of a first result screen 83. FIG. 6C is a diagram for describing an example of a second result screen 85. During the battle game, as illustrated in FIG. 6A, the battle game screen 80 is displayed. In the battle game screen 80, the ally character and the enemy character are displayed on the display 26. The ally characters are operated under computer control to damage the enemy character and receive damage from the enemy character. The enemy character operates under computer control to damage the ally characters or receive damage from the ally characters.

When damage points are given to the enemy character, the damage points are subtracted from the life points of the enemy character. Similarly, when damage points are given to the ally character, the damage points are subtracted from the life points of the ally character. When the life points of all the enemy characters become 0, the player wins (clears), and when the life points of all the ally characters become 0 (loses), the player loses.

Here, at a lower portion of the battle game screen 80, as illustrated in FIG. 6A, an ally character display area 81 is provided. In the ally character display area 81, life points 81a and a special skill gauge 81b for each ally character are displayed. The special skill gauge 81b rises when the ally character receives damage from the enemy character and when the ally character causes damage to the enemy character. When the special skill gauge 81b reaches a predetermined maximum value, the ally character can use the special skill. With the special skill, the damage points given to the enemy character are larger than that of a normal attack, life points of the ally character are recovered, or a special effect is given to the enemy character.

Here, two patterns are provided for a method of using the special skill. One is a method in which the player operates (taps) the ally character displayed in the ally character display area 81 with the special skill gauge 81b at a maximum value. The other is a method in which the ally character uses the special skill under computer control when the special skill gauge 81b reaches the maximum value in an automatic activation state. An automatic selection operation portion 82 is displayed on the battle game screen 80, and the player can switch between the automatic activation state and a manual activation state by operating the automatic selection operation portion 82. When the automatic selection operation portion 82 is operated (tapped) in the manual activation state, the automatic activation state in which the special skill is automatically used is set. In addition, when the automatic selection operation portion 82 is operated (tapped) in the automatic activation state, the manual activation state in which the special skill is manually used is set. Even in the automatic activation state, when the player operates (taps) the ally character in a state where the special skill gauge 81b has reached the maximum value and the special skill has not been used by computer control, the special skill can be used.

When the battle game ends normally (normal end), the first result screen 83 is displayed on the display 26 as illustrated in FIG. 6B. As an example, FIG. 6B illustrates the first result screen 83 when the ally characters win.

At least a portion of game result information of the battle game is displayed on the first result screen 83. Further, on the first result screen 83, a next operation portion 84 denoted by “Next” is displayed.

When the next operation portion 84 is operated (tapped), the second result screen 85 illustrated in FIG. 6C is displayed on the display 26.

At least a portion of the game result information of the battle game is displayed on the second result screen 85. In addition, on the second result screen 85, a next operation portion 86 denoted by “Next” is displayed. When the next operation portion 86 is operated (tapped), the display of the display 26 is switched from the battle screen to the normal screen. That is, the first result screen 83 and the second result screen 85 are a part of the battle screen. In the present embodiment, when the next operation portion 86 is operated (tapped), the main quest screen 72 illustrated in FIG. 5A is displayed on the display 26.

The game result information includes the ally character ID (party) of the ally characters. The game result information includes the enemy character ID of the enemy character. In addition, the game result information includes remaining status information of the ally characters and the enemy character of the end of the battle (whether the life points are 0 at the end of the battle game). In addition, the game result information includes the given damage points (total value). The game result information includes player operation information (manual activation state or automatic activation state). The game result information includes a battle log ID. The game result information includes type information (main quest, guild battle, and the like) of the battle game. In addition, the game result information includes information associated with each type of the battle game (clear information, battle game stages, and the like). In addition, the game result information includes granted item information and the like.

When the battle game is in the automatic activation state from the start to the end of the battle game and the player does not manually use the special skill, the battle game is in the automatic activation state. Otherwise, the battle game is in the manual activation state. Further, the battle log ID is uniquely assigned to each battle game. The information associated with each type of the battle game has different content for each type of the battle game.

Further, as illustrated in FIG. 5B described above, the main quest selection screen 74 displays the number of tickets owned by the player (the number of tickets associated with the player ID), and is provided with a use ticket operation portion 74a, a minus operation portion 74b, and a plus operation portion 74c.

The use ticket operation portion 74a, the minus operation portion 74b, and the plus operation portion 74c are enabled only in a battle game in which three stars are obtained as clear information and cannot be operated in a battle game in which three stars are not obtained as clear information.

In a case where the use ticket operation portion 74a, the minus operation portion 74b, and the plus operation portion 74c are enabled, each time the plus operation portion 74c is operated (tapped), the text in the use ticket operation portion 74a is displayed so as to display an increase of one such as “use two tickets” or “use three tickets”. In addition, each time the minus operation portion 74b is operated (tapped), the text in the use ticket operation portion 74a is displayed so as to display a reduction of one such as “use two tickets” or “use one ticket”.

Then, for example, in a case where the text in the use ticket operation portion 74a is “use five tickets”, when the use ticket operation portion 74a is operated (tapped), it is determined that five tickets are spent and 50 stamina is consumed.

Party creation on the party selection screen 77 illustrated in FIG. 5C and the execution of the battle game on the battle game screen 80 illustrated in FIG. 6A are omitted (skipped). Accordingly, all (five) battle games are regarded as being cleared, and the items obtained in the five battle games are collectively displayed.

In this manner, by spending the tickets, the battle game in which three stars are obtained as the clear information is omitted, and the battle game is treated as being cleared. As a result, the player can collect items in a shorter amount of time.

Also, as described above, when the dungeon battle selection operation portion 71c is operated (tapped) by the player, a dungeon battle screen (not illustrated) for executing “Dungeon Battle” is displayed on the display 26. In a dungeon battle, one dungeon selected by the player from among a plurality of dungeons can be played once within a preset time period (for example, from 5:00 to 4:59 the next day).

Each dungeon is solo-play content including a plurality of stages in which the player attempts to defeat the enemy characters in each stage and attack a boss enemy character in the final stage. A treasure chest is provided in each stage, and a battle game with an enemy character in each stage is executed. The basic part of the battle game to be executed is the same as that of the main quest.

Further, as described above, the battle game in the dungeon battle is a battle game that can be played without consuming stamina.

Also, it is possible to obtain various rewards by defeating the enemy characters in each stage. In addition, each selected dungeon is completed (cleared) by defeating the boss enemy character in the final stage.

The plurality of dungeons have different difficulty levels. In the present embodiment, the difficulty levels include “NORMAL”, “HARD”, “VERY HARD”, and “EXTREME”. The difficulty level of the battles increases in the order of “NORMAL”<“HARD”<“VERY HARD”<“EXTREME”<“EXTREME II”<“EXTREME III”<“EXTREME IV”. Each dungeon has a different unlock condition depending on the difficulty level and is unlocked by clearing a specific “Main Quest”.

In the present embodiment, for a completed (cleared) dungeon, use of a skip function is permitted from the next time. When the skip function is used, the player can obtain a reward, omitting the execution of the battle game with the enemy characters of each stage and the boss enemy character in the dungeon.

Also, as described above, when the exploration battle selection operation portion 71d is operated (tapped) by the player, an exploration battle screen (not illustrated) for executing “Exploration Battle” is displayed on the display 26. In the present embodiment, exploration battles of a plurality of exploration types are provided. Specifically, a first exploration battle and a second exploration battle provided as the plurality of exploration types.

In the first exploration battle, a battle game with an enemy character is executed. When the player wins the battle game, the player can obtain a “portion” which is an item for increasing the experience of the ally character as a reward. The basic part of the battle game to be executed is the same as that of the main quest.

In the second exploration battle, a battle game with an enemy character is executed. When the player wins the battle game, the player can obtain the first currency as a reward. The basic part of the battle game to be executed is the same as that of the main quest.

Further, in the present embodiment, the player can play the game a predetermined number of times (for example, twice) within a predetermined time period (for example, from 5:00 to 4:59 the next day) for each exploration type.

The first exploration battle and the second exploration battle are provided with a plurality of stages having different difficulty levels. The player can select one of the stages and play the battle game corresponding to the selected stage. The basic part of the battle game to be executed is the same as that of the main quest.

Further, as described above, the battle game in the exploration battle is a battle game that can be played without consuming stamina.

In addition, in the present embodiment, for a completed (cleared) exploration battle, the use of the skip function is permitted by spending a skip ticket from the next time. When the skip function is used, the player can obtain a reward, omitting the execution of the battle game in the exploration battle.

Also, as described above, when the 1V1 battle selection operation portion 71e is operated (tapped) by the player, a 1V1 battle screen (not illustrated) for executing “1V1 Battle” is displayed on the display 26.

The 1V1 battle is a battle game in which a player fights against a 1V1 party pre-associated with another player ID. That is, each player sets a party for 1V1 in advance.

On the 1V1 battle screen (not illustrated), a plurality of parties of other player are displayed, and the player selects a party to battle against. Similarly to the main quest, the player decides on their party and starts the battle game. In the battle game of the 1V1 battle, the basic part of the battle game to be executed is the same as that of the main quest, except that the 1V1 battle is set in advance and that the player cannot switch between an automatic state and a manual state.

In addition, on the 1V1 battle screen (not illustrated), the player can receive predetermined in-game currency (1V1 battle coin) that is produced at regular intervals. For example, a predetermined number of 1V1 battle coins are produced every hour, and the produced 1V1 battle coins are accumulated on a 1V1 battle screen (not illustrated). The player can purchase a predetermined item by using the 1V1 battle coins.

An upper limit value is set for the number of 1V1 battle coins accumulated on the 1V1 battle screen (not illustrated). When the number of accumulated 1V1 battle coins reaches the upper limit value, 1V1 battle coins are not newly produced until the player receives the 1V1 battle coins. Thus, it is desirable to receive the accumulated 1V1 battle coins before reaching the upper limit value. That is, the player is periodically requested to perform an in-game task of receiving the 1V1 battle coins.

When 1V1 battle coins are not accumulated, the player cannot receive the 1V1 battle coins. In other words, it can be considered that a limit (for example, a maximum of 24 times per day) is provided for the number of times 1V1 battle coins are received.

Also, as described above, when the 3V3 battle selection operation portion 71f is operated (tapped) by the player, a 3V3 battle screen (not illustrated) for executing “3V3 Battle” is displayed on the display 26.

The 3V3 battle is a battle game in which a player fights against three 3V3 parties pre-associated with another player ID. That is, each player sets three parties for 3V3 in advance.

On the 3V3 battle screen (not illustrated), a plurality of parties of other player are displayed, and the player selects a party to battle against. In addition, the player selects three of their own parties and fights. In the battle game of the 3V3 battle, the basic part of the battle game to be executed is the same as that of the main quest, except that the 3V3 battle is set in advance and that the player cannot switch between the automatic state and the manual state.

In addition, on the 3V3 battle screen (not illustrated), the player can receive predetermined in-game currency (3V3 battle coin) that is produced at regular intervals. For example, a predetermined number of 3V3 battle coins are produced every hour, and the produced 3V3 battle coins are accumulated on a 3V3 battle screen (not illustrated). The player can purchase a predetermined item by using the 3V3 battle coins.

An upper limit value is set for the number of 3V3 battle coins accumulated on the 3V3 battle screen (not illustrated). When the number of accumulated 3V3 battle coins reaches the upper limit value, 3V3 battle coins are not newly produced until the player receives the 3V3 battle coins. Thus, it is desirable to receive the accumulated 3V3 battle coins before reaching the upper limit value. That is, the player is periodically requested to perform an in-game task of receiving the 3V3 battle coins.

When 3V3 battle coins are not accumulated, the player cannot receive the 3V3 battle coins. In other words, a limit (for example, a maximum of 24 times per day) may be provided for the number of times 3V3 battle coins are received.

As described above, when the guildhouse screen selection operation portion 41e of the home screen 40 (FIG. 3) is operated (tapped) by the player, a guildhouse screen (not illustrated) is displayed on the display 26. The player can freely arrange favorite ally characters owned by the player on the guildhouse screen and enjoy various motions of the ally characters.

In addition, the player can arrange furniture on the guildhouse screen. Some pieces of furniture have special effects that make it easier to progress through the game. For example, the furniture may include portion producing furniture, stamina producing furniture, skip ticket producing furniture, and first currency producing furniture.

Portion producing furniture produces portions at regular intervals. As described above, portions are used to increase the experience of an ally character. For example, every hour, a predetermined number of portions are produced, and the produced portions are accumulated in the portion producing furniture. The player can obtain produced portions from the portion producing furniture by tapping the portion producing furniture arranged on the guildhouse screen.

When portions are not accumulated, the player cannot receive the portions. In other words, it can be considered that a limit (for example, a maximum of 24 times per day) is provided for the number of times portions are received.

Further, the stamina producing furniture produces stamina at regular intervals. For example, every hour, a predetermined amount of stamina is produced, and the produced stamina is accumulated in the stamina producing furniture. The player can obtain produced stamina from the stamina producing furniture by tapping the stamina producing furniture arranged on the guildhouse screen to recover the stamina of the player.

When stamina is not accumulated, the player cannot receive the stamina. In other words, it can be considered that a limit (for example, a maximum of 24 times per day) is provided for the number of times stamina is received.

Further, the skip ticket producing furniture produces skip tickets at regular intervals. For example, every hour, a predetermined number of skip tickets are produced, and the produced skip tickets are accumulated in the skip ticket producing furniture. The player can obtain the skip ticket produced from the skip ticket producing furniture by tapping the ticket producing furniture arranged on the guildhouse screen.

When skip tickets are not accumulated, the player cannot receive the skip tickets. In other words, it can be considered that a limit (for example, a maximum of 24 times per day) is provided for the number of times skip tickets are received.

Further, the first currency producing furniture produces first currency at regular intervals. For example, every hour, a predetermined amount of first currency is produced, and the produced first currency is accumulated in the first currency producing furniture. The player can obtain produced first currency from the first currency producing furniture by tapping the first currency producing furniture arranged on the guildhouse screen.

The products produced and accumulated by the portion producing furniture, the stamina producing furniture, the skip ticket producing furniture and the first currency producing furniture have an upper limit value on the number thereof that can be accumulated. When the number of accumulated products reaches the upper limit value, products are not newly produced until the player receives a product at the upper limit value. Thus, it is desirable to receive the accumulated products before reaching the upper limit value. That is, the player is periodically requested to perform an in-game task of receiving the products.

When first currency is not accumulated, the player cannot receive the first currency. In other words, it can be considered that a limit (for example, a maximum of 24 times per day) is provided for the number of times first currency is received.

FIG. 7 is a diagram for describing an example of the gacha screen 100. As described above, when the gacha screen selection operation portion 41f of the menu bar 41 is operated (tapped) by the player, the gacha screen 100 illustrated in FIG. 7 is displayed on the display 26.

In the present embodiment, gacha types include “Normal Gacha” for obtaining items and “Focus Gacha” and “Premium Gacha” for obtaining an ally character. As illustrated in FIG. 7, a gacha type selection bar 101 is displayed in an upper portion of the gacha screen 100. In the gacha type selection bar 101, a normal gacha screen operation portion 101a denoted by “Normal”, a premium gacha selection operation portion 101b denoted by “Premium”, and a focus gacha selection operation portion 101c denoted by “Focus” are displayed.

As illustrated in FIG. 7, on the gacha screen 100, the operation portion corresponding to the selected gacha type is highlighted so that the selected gacha type can be identified.

When the premium gacha selection operation portion 101b is operated (tapped) by the player, a premium gacha screen (not illustrated) corresponding to “Premium Gacha” is displayed on the display 26.

When the focus gacha selection operation portion 101c is operated (tapped) by the player, a focus gacha screen (not illustrated) corresponding to “Focus Gacha” is displayed on the display 26.

In each gacha type for obtaining ally characters, the player can participate in a lottery by spending a predetermined amount of the second currency. In addition, each gacha type is different in terms of at least one of the ally characters in the lottery or the lottery probability (winning probability) of each ally character.

When the normal gacha screen operation portion 101a is operated (tapped) by the player, the gacha screen 100 illustrated in FIG. 7 corresponding to “Normal Gacha” is displayed on the display 26.

In the present embodiment, with “Normal Gacha”, an item can be obtained twice free of charge within a preset time period (for example, from 5:00 to 4:59 the next day). Specifically, for example, an item can be obtained free of charge once between 05:00 and 11:59 and once between 12:00 and 04:59 the next day.

In the server 1000, a lottery table in which the lottery probability of items or ally characters is set for each type of gacha and opening period information (information indicating a time period during which the lottery table can be referenced) are stored, and a lottery (gacha) is performed with reference to the lottery table of the selected type of gacha.

Further, as illustrated in FIG. 7, a lottery operation portion 102 for executing a lottery is displayed on the gacha screen 100. When the lottery operation portion 102 is operated (tapped) by the player, a lottery is performed in the server 1000 with reference to the corresponding lottery table. Then, the item or ally character determined by the lottery is given to the player.

As described above, the shop screen selection operation portion 43a of the home screen 40 (FIG. 3) is operated (tapped) by the player, the normal shop screen 110 (FIG. 8A) where items can be purchased is displayed. FIG. 8A is a diagram for describing an example of the normal shop screen 110. FIG. 8B is a diagram for describing an example of a bonus shop screen 120.

As illustrated in FIG. 8A, normal selection operation portion 111 denoted by “Normal” is displayed on the normal shop screen 110. In addition, on the normal shop screen 110, a plurality of item purchase display areas 112 are displayed. The item purchase display area 112 is provided with a purchasable item, first currency required for purchasing the item, and a purchase operation portion 113 for purchasing the item.

When the player operates (taps) the purchase operation portion 113, the player can purchase the item displayed in the item purchase display area 112 provided with the purchase operation portion 113.

In addition, in the item purchase display areas 112 displayed on the normal shop screen 110, the content of the item is replaced or the item can be purchased again at a predetermined cycle within a preset time period (for example, from 5:00 to 4:59 the next day).

When each of the battle games described above is cleared, the server 1000 determines through a lottery whether the bonus shop appears. In addition, in the server 1000, in a case where it is determined for the bonus shop to appear, items that can be purchased in the bonus shop are determined.

An upper limit value (for example, five times) is set for the number of times that the bonus shop can appear within a preset time period (for example, from 5:00 to 4:59 the next day). However, the upper limit value of the number of times the bonus shop can appear need not be set. In addition, a bonus shop that has appeared is closed at a preset timing (for example, 5:00 every day). Note that a bonus shop that has appeared may be closed at any timing within a preset time period (for example, from 5:00 to 4:59 the next day) in accordance with a player operation.

In a case where the appearance of a bonus shop is determined, the bonus shop screen 120 illustrated in FIG. 8B can be displayed. As illustrated in FIG. 8B, a bonus selection operation portion 121 denoted by “Bonus” is displayed together with the normal selection operation portion 111 on the bonus shop screen 120.

As illustrated in FIG. 8B, a plurality of item purchase display areas 122 are also displayed on the bonus shop screen 120. However, on the bonus shop screen 120, items that are at least partially different from those on the normal shop screen 110 can be purchased.

FIG. 9A is a first diagram for describing an example of the first currency purchase screen 130. FIG. 9B is a second diagram for describing an example of the first currency purchase screen 130. As described above, when the player operates (taps) the first currency purchase screen operation portion 42c of the home screen 40 (FIG. 3), the first currency purchase screen 130 is displayed on the display 26.

As illustrated in FIG. 9A, a purchase operation portion 131 is displayed on the first currency purchase screen 130. When the player operates (taps) the purchase operation portion 131, the player can obtain (purchase) the first currency by spending a predetermined amount of the second currency. Further, in the present embodiment, when the first currency is purchased, an item (for example, a skip ticket) is given to the player as a bonus.

Also, as illustrated in FIG. 9A, a purchase history display portion 132 is displayed on the first currency purchase screen 130. As illustrated in FIG. 9B, a purchase history 133 of the first currency purchased within a preset time period (for example, from 5:00 to 4:59 the next day) is displayed as a list in the purchase history display portion 132. In the present embodiment, a limit (for example, 70 times) is set for the number of times that the first currency can be purchased within a preset time period (for example, from 5:00 to 4:59 the next day).

In the present embodiment, when the player operates (taps) the purchase operation portion 131, the second currency owned by the player is subtracted in the server 1000. Further, the purchased first currency is given to the player.

Further, a lottery for an item to be given to the player as a bonus is performed. Then, the item determined through the lottery is given to the player. As illustrated in FIG. 9B, the amount of the second currency spent, the amount of the first currency purchased, and the given bonus item are displayed in the purchase history 133.

In addition, as illustrated in FIGS. 9A and 9B, a cancel operation portion 134 denoted by “Cancel” is displayed in the first currency purchase screen 130. When the cancel operation portion 134 is operated (tapped) by the player, the display of the first currency purchase screen 130 on the display 26 ends.

As described above, when the guild screen selection operation portion 43b of the home screen 40 (FIG. 3) is operated (tapped), a guild screen (not illustrated) is displayed on the display 26. In the present embodiment, a player can belong to a group called a guild. In the present embodiment, players (guild members) belonging to the same guild can temporarily borrow a support character (ally character) that is usable in a battle game from another guild member.

Further, the player can communicate with other players belonging to the guild in the game. For example, the player can transmit a “like” indicating positivity or shared feelings to other players belonging to the guild. In the present embodiment, a player who has received a “like” from another player can obtain a predetermined item as a reward. The number of times a “like” can be transmitted within a preset time period (for example, from 5:00 to 4:59 the next day) is limited (for example, once).

FIG. 10A is a diagram for describing an example of the daily missions screen 140. As described above, when the mission screen selection operation portion 43c of the home screen 40 (FIG. 3) is operated (tapped), the daily missions screen 140 illustrated in FIG. 10A is displayed on the display 26.

In the present embodiment, so-called daily missions are given to the player. The player can obtain a predetermined bonus (reward) by completing predetermined in-game tasks given as the daily missions within a preset time period (for example, from 5:00 to 4:59 the next day).

As illustrated in FIG. 10A, the menu bar 41 is displayed on the daily missions screen 140. A list display portion 141 is displayed on the daily missions screen 140.

In the list display portion 141, mission display portions 142 indicating the daily missions given to the player are displayed in a list. Note that the player can check all the mission display portions 142 by performing a slide operation on the list display portion 141.

In the present embodiment, in-game tasks given to the player as daily missions include logging in between 12:00 and 4:59, logging in between 18:00 and 04:59, clearing the main quest 10 times, clearing the main quest 20 times, clearing the exploration battle 4 times, clearing the dungeon battle once, playing the 1V1 battle once, playing the 3V3 battle once, executing the normal gacha once, sending a “like” to a guild member, and the like.

As illustrated in FIG. 10A, the daily missions described above are displayed on the mission display portions 142. In addition, as illustrated in FIG. 10A, a challenge operation portion 142a denoted by “Challenge” is displayed in the mission display portion 142 corresponding to the uncompleted daily missions.

When the player operates (taps) the challenge operation portion 142a, a screen (referred to as an execution screen) for executing the corresponding uncompleted daily missions is displayed on the display 26.

Specific examples of the execution screen displayed on the display 26 include the ally character confirmation screen 50 (FIG. 4A), the quest screen 70 (FIG. 4C), the main quest screen 72 (FIG. 5A), the guildhouse screen (not illustrated), the gacha screen 100 (FIG. 7), the first currency purchase screen 130 (FIG. 9A), the 1V1 battle screen (not illustrated), the 3V3 battle screen (not illustrated), the dungeon battle screen (not illustrated), the exploration battle screen (not illustrated), the normal shop screen 110 (FIG. 8A), and the bonus shop screen 120 (FIG. 8B).

In addition, a receive operation portion 142b denoted by “Receive” is displayed in the mission display portion 142 corresponding to the completed daily missions. When the player operates (taps) the receive operation portion 142b, a reward reception screen 150 (FIG. 10B) described below is displayed on the display 26, and the player can receive a reward corresponding to the completed daily missions.

FIG. 10B is a diagram for describing an example of the reward reception screen 150. As illustrated in FIG. 10B, rewards corresponding to the completed daily missions are displayed in a list on the reward reception screen 150.

Further, as illustrated in FIG. 10B, a close operation portion 151 denoted by “Close” is displayed on the reward reception screen 150. Then, when the player operates (taps) the close operation portion 151, the display of the reward reception screen 150 ends.

In addition, as illustrated in FIG. 10A, the mission display portions 142 corresponding to daily missions for which reward reception is complete are displayed grayed-out.

As illustrated in FIG. 10A, a receive all operation portion 143 denoted by “Receive All” is displayed on the daily missions screen 140. When the player operates (taps) the receive all operation portion 143, the player can collectively receive all of the rewards corresponding to the completed daily missions.

In the present embodiment, the right to be able to obtain a reward by completing a daily mission is reset every day at the same time (for example, 5:00). Thus, the player can repeatedly obtain the reward by completing the daily mission every day. In this manner, the daily missions motivate the player to play the game.

On the other hand, as described above, many in-game tasks are given in the daily missions. In addition, the player performs in-game tasks that are recommended to be performed every day on a daily basis even though the in-game tasks are not part of the given daily missions. Such in-game tasks recommended to be performed every day on a daily basis are, for example, in-game task including content (for example, exploration battle, dungeon battle, purchase of first currency, or the like) in which the number of executions in one day is limited but items, in-game currency, and experience can be obtained more efficiently than in other content.

In this manner, with the number of tasks for the player increasing, the management of the progress status of the in-game tasks and player operations become complicated, and the player may become less motivated to play the game. In addition, it takes a relatively long time to execute all of the in-game tasks every day, which may cause the player to feel annoyed and to become less motivated to play the game.

Thus, in the present embodiment, a notification function is provided that can manage the in-game tasks given for the daily missions and the in-game tasks performed every day on a daily basis. Further, in the present embodiment, an automatic execution function is provided for simplifying the execution of the in-game tasks given for the daily missions and the in-game tasks performed every day on a daily basis. With these functions, player-friendliness is improved, and the risk of the player to become less motivated to play the game can be suppressed.

FIG. 11A is a first diagram for describing an example of the schedule screen 160. As described above, when the player operates (taps) the schedule screen selection operation portion 45 of the home screen 40 (FIG. 3), the schedule screen 160 is displayed on the display 26. In a case where a preset display condition is satisfied, the schedule screen 160 is displayed on the display 26.

In the present embodiment, when the home screen 40 is displayed on the display 26 for the first time after the game application is activated, the schedule screen 160 is displayed on the display 26 assuming that the preset display condition is satisfied. The player may be allowed to freely set the display timing and the display frequency of the schedule screen 160 on a menu screen (not illustrated).

As illustrated in FIG. 11A, a notification setting operation portion 161 denoted by “Notification Settings” is displayed on the schedule screen 160. When the notification setting operation portion 161 is operated (tapped) by the player, a notification setting screen 170 (FIG. 11B) described below is displayed on the display 26.

FIG. 11B is a diagram for describing an example of the notification setting screen 170. As illustrated in FIG. 11B, a notification setting content display 171 is displayed on the notification setting screen 170. In the notification setting content display 171, a list of in-game tasks to which the notification function can be applied is displayed. The player can check all of the in-game tasks to which the notification function can be applied by performing a slide operation on the notification setting content display 171.

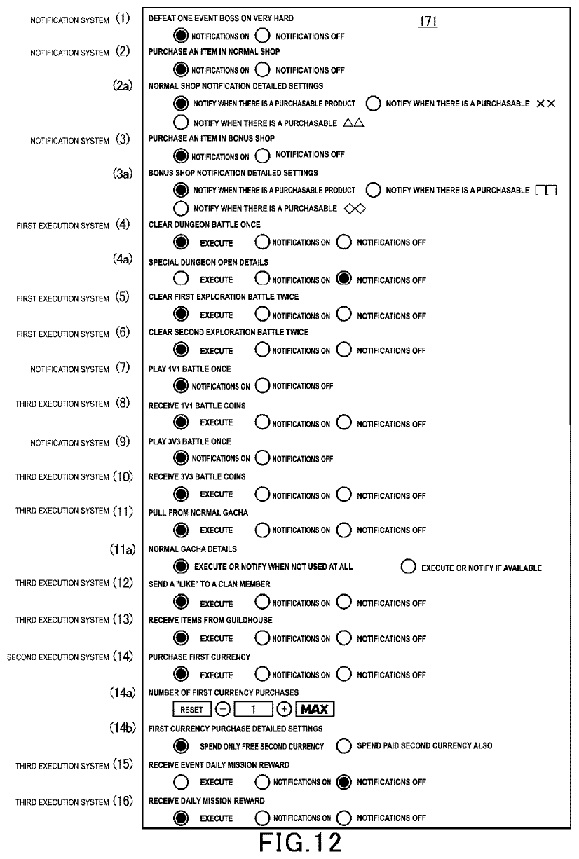

FIG. 12 is a diagram for describing an example of the notification setting content display 171. In the present embodiment, depending on the content of the in-game task to which the notification function can be applied, the in-game task is sorted into either a notification system or an execution system. Specifically, in the present embodiment, an in-game task that can use only the notification function is sorted into the notification system. In addition, an in-game task that can use both the notification function and the automatic execution function is sorted into the execution system.

In the present embodiment, the execution system includes a first execution system, a second execution system, and a third execution system. Specifically, the in-game tasks involving the execution of the battle game are mainly sorted into the first execution system. In addition, the in-game tasks involving a purchase task using in-game currency are mainly sorted into the second execution system. In addition, the in-game tasks that do not involve the execution of a battle game and involve a task of receiving some item or in-game currency are sorted into the third execution system.

Specifically, the notification system includes (1) an in-game task of defeating one event boss on VERY HARD, (2) an in-game task of purchasing an item from the normal shop, (3) an in-game task of purchasing an item from the bonus shop, (7) an in-game task of playing the 1V1 battle once, and (9) an in-game task of playing the 3V3 battle once in FIG. 12.

Regarding the in-game tasks included in the notification system, the player can set any item to the check box denoted by “Notifications ON” or the check box denoted by “Notifications OFF”. The in-game tasks set to “Notifications ON” are displayed (notified) on the schedule screen 160. The in-game tasks set to “Notifications OFF” are not displayed (notified) on the schedule screen 160.

As illustrated in FIG. 12, detailed setting items illustrated in (2a) of FIG. 12 are further provided for (2) an in-game task of purchasing an item from the normal shop in FIG. 12.

Specifically, it is possible to set that a notification is performed in a case where, in the normal shop, one or more products can be purchased by the player, one or more predetermined products can be purchased by the player, or one or more other predetermined products can be purchased by the player.

As illustrated in FIG. 12, detailed setting items illustrated in (3a) of FIG. 12 are further provided for (3) an in-game task of purchasing an item from the bonus shop in FIG. 12.

Specifically, it is possible to set that a notification is performed in a case where, in the bonus shop, one or more products can be purchased by the player, one or more predetermined products can be purchased by the player, or one or more other predetermined products can be purchased by the player.

The first execution system includes (4) an in-game task of clearing the dungeon battle once, (5) an in-game task of clearing the first exploration battle twice, and (6) an in-game task of clearing the second exploration battle twice in FIG. 12.

Regarding the in-game tasks included in the first execution system, the player can set any item to the check box denoted by “Execute”, the check box denoted by “Notifications ON”, or the check box denoted by “Notifications OFF”.

The in-game task set to “Execute” is displayed (notified) on the schedule screen 160, and the use of the automatic execution function is permitted.

Also, the in-game tasks set to “Notifications ON” are displayed (notified) on the schedule screen 160. Also, the in-game tasks set to “Notifications OFF” are not displayed (notified) on the schedule screen 160.

As described above, in the present embodiment, in a case where the automatic execution function is used for dungeons, the automatic execution function may be used for a dungeon having the highest difficulty level among dungeons for which the skip function can be used. Similarly, in a case where the automatic execution function is used for the first exploration battle and the second exploration battle, the automatic execution function may be used for a battle having the highest difficulty level from among the first exploration battle and the second exploration battle in which the skip function can be used.

As illustrated in FIG. 12, detailed setting items illustrated in (4a) of FIG. 12 are further provided for (4) an in-game task of clearing the dungeon battle once in FIG. 12.

Specifically, while a special dungeon is open, as an exception, the setting can be changed to any one of “Execute”, “Notifications ON”, or “Notifications OFF”. Note that the special dungeon is a type of stage in the dungeon and can be selected by the player only within a preset time period.

In addition, as described above, in the present embodiment, the in-game tasks including (7) the in-game task of playing the 1V1 battle once and (9) the in-game task of playing the 3V3 battle once in FIG. 12 are included in the notification system while not limited thereto. For example, the in-game tasks including (7) the in-game task of playing the 1V1 battle once and (9) the in-game task of playing the 3V3 battle once in FIG. 12 may be included in the first execution system. In this case, in a case where the automatic execution function is used for the 1V1 battle or the 3V3 battle, the automatic execution function may be used without requiring the player to select a party to fight. For example, another player of the strongest party or another player of the weakest party may be automatically selected as an opponent to fight from among other players available to fight.

The second execution system includes (14) the in-game task of purchasing the first currency in FIG. 12.

Regarding the in-game tasks included in the second execution system, the player can set any item to the check box denoted by “Execute”, the check box denoted by “Notifications ON”, or the check box denoted by “Notifications OFF”.

As illustrated in FIG. 12, detailed setting items illustrated in (14a) and (14b) of FIG. 12 are further provided for (14) the in-game task of purchasing the first currency in FIG. 12. Specifically, it is possible to set the number of purchases of the first currency and to set whether to spend only the second currency obtained free of charge or to spend both the second currency obtained free of charge and the second currency obtained for a fee when purchasing the first currency.

The third execution system includes (8) an in-game task of collecting 1V1 battle coins, (10) an in-game task of collecting 3V3 battle coins, (11) an in-game task of pulling from the normal gacha, (12) an in-game task of sending a “like” to a guild member, (13) an in-game task of receiving an item from the guildhouse, (15) an in-game task of receiving an event daily mission reward, and (16) an in-game task of receiving a daily mission reward of FIG. 12.

Regarding the in-game tasks included in the third execution system, the player can set any item to the check box denoted by “Execute”, the check box denoted by “Notifications ON”, or the check box denoted by “Notifications OFF”.

As described above, in the present embodiment, for example, from the normal gacha, an item can be obtained free of charge once between 05:00 and 11:59 and once between 12:00 and 04:59 the next day. Regarding this, as illustrated in FIG. 12, detailed setting items illustrated in (11a) of FIG. 12 are further provided for (11) the in-game task of pulling from the normal gacha in FIG. 12.

Specifically, it is possible to set for display (notification) on the schedule screen 160 in a case of when the normal gacha has not been used even once within a preset time period (for example, from 5:00 to 4:59 the next day) or when the normal gacha is available to be used. Alternatively, it is possible to set for display (notification) on the schedule screen 160 and for permission to use the automatic execution function in a case of when the normal gacha has not been used even once within a preset time period (for example, from 5:00 to 4:59 the next day) or when the normal gacha is available to be used.

In (1) the in-game task of defeating one event boss on VERY HARD and (15) the in-game task of receiving an event daily mission reward of FIG. 12 are setting items for an event quest that can be executed within a preset time period (for example, from 5:00 to 4:59 the next day).

Although detailed description is omitted, the player can play the event quest only during a preset time period (for example, over a 10-day period). In an event quest, the player can obtain a boss battle challenge ticket by clearing the battle game of the event quest. The player can execute the battle game with the event boss by spending a predetermined number of boss battle challenge tickets. The basic part of the battle game of the event quest is the same as that of the main quest. With respect to the in-game content (event) that can be played by the player only during a preset time period (for example, over a 10-day period) as described above, the in-game task of participating in the event during the open period of the event may be included in the notification system.

Here, the battle game with the event boss has a plurality of levels of difficulty. In the present embodiment, a limit (for example, once) is set on the number of times that the battle game with the event boss on VERY HARD corresponding to a high difficulty level can be executed within a preset time period (for example, from 5:00 to 4:59 the next day).

In the present embodiment, the execution of a battle game with the event boss on VERY HARD once a day is given as a daily mission while an event quest is open (hereinafter referred to as an event daily mission). That is, by executing the battle game with the event boss on VERY HARD once a day, the player can complete the event daily mission and obtain a predetermined bonus (reward).

However, with respect to (1) the in-game task of defeating one event boss on VERY HARD and (15) the in-game task of receiving an event daily mission reward in FIG. 12, the player can change the setting contents both during the open period of the event quest and outside of the open period. However, regardless of the setting contents, (1) the in-game task of defeating one event boss on VERY HARD and (15) the in-game task of receiving an event daily mission reward in FIG. 12 are not displayed on the notification target display portion 162 outside the open period of the event quest.

Returning to FIG. 11B, a setting operation portion 172 denoted by “Set” and a cancel operation portion 173 denoted by “Cancel” are displayed on notification setting screen 170. When the cancel operation portion 134 is operated (tapped) by the player, the display of the notification setting screen 170 on the display 26 ends and the setting content is discarded.

In addition, when the setting operation portion 172 is operated (tapped) by the player, the settings of the check boxes corresponding to each setting item of the notification setting content display 171 are stored. At this time, the player terminal 1 generates notification target setting information based on the setting content and transmits the notification target setting information to the server 1000.

Returning to FIG. 11A, the schedule screen 160 is provided with the notification target display portion 162. In the notification target display portion 162, a list of setting items set to “Notifications ON” or “Execute” is set is displayed based on the notification target setting information.

With respect to the setting items set to “Notifications ON”, a move operation portion 162a denoted by “Move” is correspondingly displayed. When the move operation portion 162a is operated (tapped) by the player, an execution screen for executing the corresponding in-game task is displayed on the display 26.

In addition, for example, when the player operates (taps) the move operation portion 162a corresponding to the in-game task of “defeating one event boss on VERY HARD”, an execution screen (predetermined execution screen) in which a battle game with the event boss on VERY HARD is selected may be displayed on the display 26. Alternatively, an execution screen (event top screen) provided with an operation portion capable of displaying a predetermined execution screen may be displayed on the display 26.

As illustrated in FIG. 11A, an automatically execute all operation portion 163 denoted by “Automatically execute all” is displayed on the schedule screen 160. When the automatically execute all operation portion 163 is operated (tapped) by the player, all of the executable in-game tasks from among the in-game tasks corresponding to a setting item set to “Execute” are executed. Note that, in the present embodiment, in-game tasks are automatically executed collectively for each of the above-described systems. Specifically, an in-game task that has not yet been executed within a preset time period (for example, from 5:00 to 4:59 the next day) can be set as an executable in-game task.

Specifically, for example, in a case where automatic execution is performed for all of the first execution system, the second execution system, and the third execution system, first, in-game tasks sorted into the first execution system are automatically executed collectively. At this time, execution information indicating each in-game task sorted into the first execution system to be executed is transmitted from the player terminal 1 to the server 1000.

Specifically, the execution information transmitted at this time includes information indicating that, from among the in-game tasks to be executed with a check in the “Execute” check box, each of the in-game tasks sorted into the first execution system is to be executed.

In the server 1000, based on the received execution information, reward list information indicating a reward for each in-game task sorted into the first execution system to be executed is generated. The player terminal 1 obtains the reward list information generated by the server 1000.

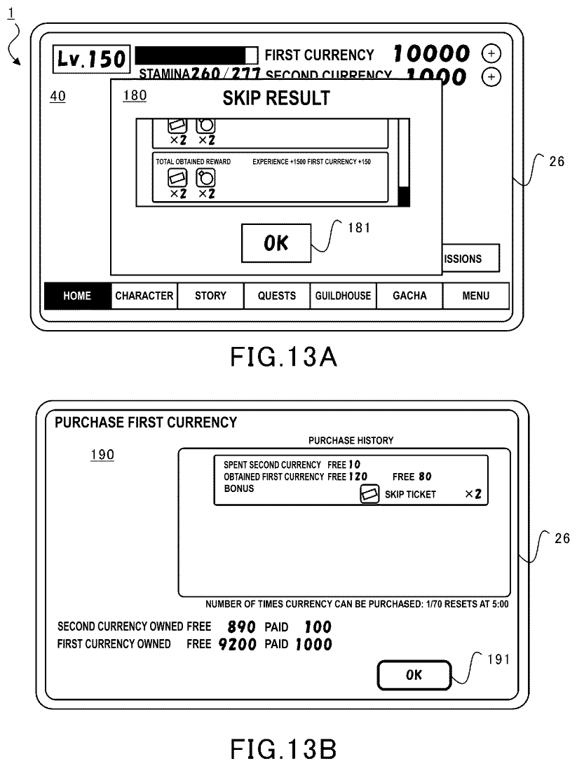

Then, the player terminal 1 displays a first execution system result screen 180 (FIG. 13A) based on the obtained reward list information on the display 26. FIG. 13A is a diagram for describing an example of a first execution system result screen 180. As illustrated in FIG. 13A, on the first execution system result screen 180, the rewards for the in-game tasks to be executed sorted into the first execution system are displayed in a list.

Further, as illustrated in FIG. 13A, on the first execution system result screen 180, an OK operation portion 181 denoted by “OK” is displayed. When the player operates (taps) the OK operation portion 181, the display of the first execution system result screen 180 ends.

When the OK operation portion 181 is operated (tapped) by the player, the in-game tasks sorted into the second execution system are automatically executed collectively. At this time, execution information indicating each in-game task sorted into the second execution system to be executed is transmitted from the player terminal 1 to the server 1000.

Specifically, the execution information transmitted at this time includes information indicating that, from among the in-game tasks to be executed with a check in the “Execute” check box, each of the in-game tasks sorted into the second execution system is to be executed.

In the server 1000, based on the received execution information, reward list information indicating a reward for each in-game task sorted into the second execution system to be executed is generated. The player terminal 1 obtains the reward list information generated by the server 1000.

Then, the player terminal 1 displays a second execution system result screen 190 (FIG. 13B) based on the obtained reward list information on the display 26. FIG. 13B is a diagram for describing an example of the second execution system result screen 190. As illustrated in FIG. 13B, on the second execution system result screen 190, the rewards for the in-game tasks to be executed sorted into the second execution system are displayed in a list.

Further, as illustrated in FIG. 13B, on the second execution system result screen 190, an OK operation portion 191 denoted by “OK” is displayed. When the player operates (taps) the OK operation portion 191, the display of the second execution system result screen 190 ends.

When the OK operation portion 191 is operated (tapped) by the player, the in-game tasks sorted into the third execution system are automatically executed collectively. At this time, execution information indicating each in-game task sorted into the third execution system to be executed is transmitted from the player terminal 1 to the server 1000.

Specifically, the execution information transmitted at this time includes information indicating that, from among the in-game tasks to be executed with a check in the “Execute” check box, each of the in-game tasks sorted into the third execution system is to be executed.

In the server 1000, based on the received execution information, reward list information indicating a reward for each in-game task sorted into the third execution system to be executed is generated. The player terminal 1 obtains the reward list information generated by the server 1000.

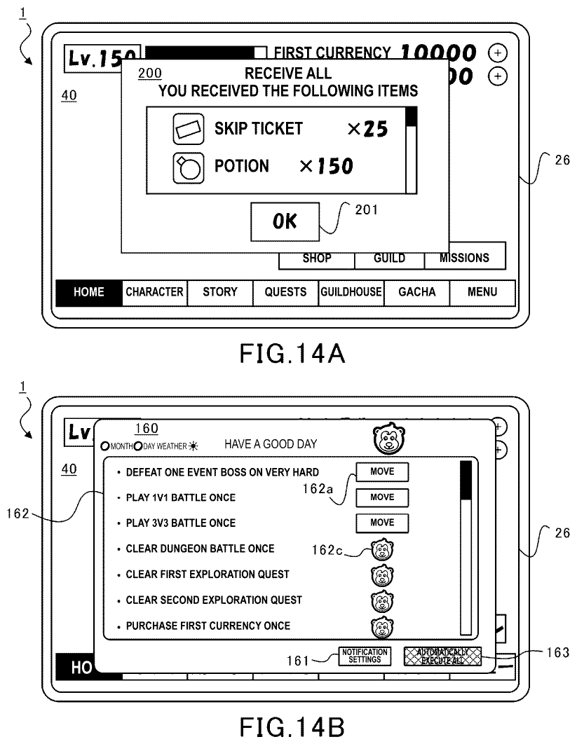

Then, the player terminal 1 displays a third execution system result screen 200 (FIG. 14A) based on the obtained reward list information on the display 26. FIG. 14A is a diagram for describing an example of the third execution system result screen 200. As illustrated in FIG. 14A, on the third execution system result screen 200, the rewards for the in-game tasks to be executed sorted into the third execution system are displayed in a list.

Further, as illustrated in FIG. 14A, on the third execution system result screen 200, an OK operation portion 201 denoted by “OK” is displayed. When the player operates (taps) the OK operation portion 201, the display of the third execution system result screen 200 ends.

When the display of the third execution system result screen 200 ends, the schedule screen 160 (FIG. 14B) is displayed on the display 26. As illustrated in FIG. 14B, on the schedule screen 160, an identification display 162c is displayed for notifying the player that the in-game task automatically executed as described above has been executed. In addition, also in a case where the move operation portion 162a is operated (tapped) by the player and the corresponding in-game task is executed, the identification display 162c is displayed for notifying the player that the executed in-game task has been executed.

In the present embodiment, an icon of a predetermined ally character set in advance is displayed as the identification display 162c. However, the content of the identification display 162c is not limited thereto. For example, the identification display 162c or a symbol such as a check mark indicating a player being notified of execution completion may be displayed.

Further, as illustrated in FIG. 14B, in a case where there is no in-game task for which the automatic execution function can be used, the automatically execute all operation portion 163 is displayed in an inoperable mode.

With respect to the setting items set to “Execute”, an execute operation portion 162b denoted by “Execute” is correspondingly displayed as illustrated in FIG. 11A.

When the execute operation portion 162b is operated (tapped) by the player, the corresponding in-game task is automatically executed. In other words, in a case where the execute operation portion 162b has been operated (tapped) by the player, only the one in-game task corresponding to the operated (tapped) execute operation portion 162b is automatically executed.

In this case, the first execution system result screen 180, the second execution system result screen 190, or the third execution system result screen 200 is displayed on the display 26 according to the system of the executed in-game task.

As described above, in the present embodiment, by providing the notification function and the automatic execution function, player-friendliness can be improved, and the risk of the player to be become less motivated to play the game can be suppressed. In addition, in the present embodiment, it is possible to freely set whether to remind the player (notify the player so they do not forget) to execute an in-game task that is recommended to be performed every day on a daily basis even though the in-game task is not given as a daily mission, in other words, an in-game task that is not actively encouraged to be executed, according to the player's preference. Next, the functional configuration of the player terminal 1 and the server 1000 relating to the notification function and the automatic execution function described above will be described.

### Control Processing in Player Terminal 1 and Server 1000

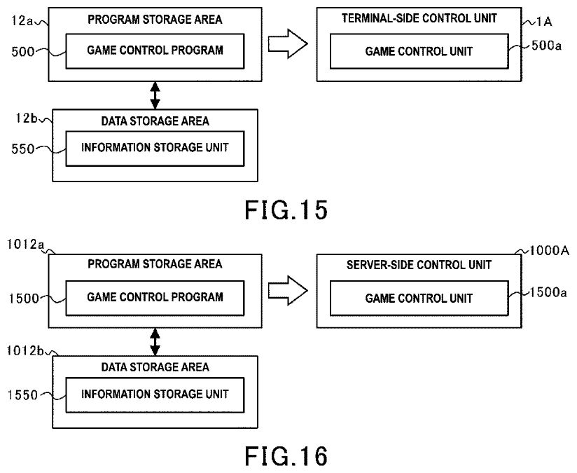

FIG. 15 is a diagram for describing the configuration of the memory 12 in the player terminal 1 and a function thereof as a computer. A game control program 500 is stored in a program storage area 12a. The above-described program stored in the program storage area 12a is merely an example, and many other programs are also provided in the program storage area 12a.

The data storage area 12b is provided with an information storage unit 550 for storing various types of information relating to the automatic execution function and the notification function. The above-described storage unit provided in the data storage area 12b is merely an example, and many other storage units may be provided in the data storage area 12b.

The CPU 10 runs each program stored in the program storage area 12a and updates the data in each storage unit of the data storage area 12b. The CPU 10 causes the player terminal 1 (computer) to function as a terminal-side control unit 1A by operating each program stored in the program storage area 12a. The terminal-side control unit 1A includes a game control unit 500a.

Specifically, the CPU 10 operates the game control program 500 to cause the computer to function as the game control unit 500a.

FIG. 16 is a diagram for describing the configuration of the memory 1012 in the server 1000 and a function thereof as a computer. A game control program 1500 is stored in a program storage area 1012a. The above-described program stored in the program storage area 1012a is merely an example, and many other programs are also provided in the program storage area 1012a.

A data storage area 1012b is provided with an information storage unit 1550 for storing various types of information relating to the automatic execution function and the notification function. The above-described storage unit provided in the data storage area 1012b is merely an example, and many other storage units may be provided in the data storage area 1012b.

The CPU 1010 runs each program stored in the program storage area 1012a and updates the data in each storage unit of the data storage area 1012b. The CPU 1010 causes the server 1000 (computer) to function as a server-side control unit 1000A by operating each program stored in the program storage area 1012a. The server-side control unit 1000A includes a game control unit 1500a.

Specifically, the CPU 1010 operates the game control program 1500 to cause the computer to function as the game control unit 1500a. Hereinafter, a part of the processing relating to the notification function and the automatically execute all function executed by the terminal-side control unit 1A and the server-side control unit 1000A will be described. Note that the processing relating to other functions executed by the terminal-side control unit 1A and the server-side control unit 1000A will not be described.

Communication Processing Between Player Terminal 1 and Server 1000

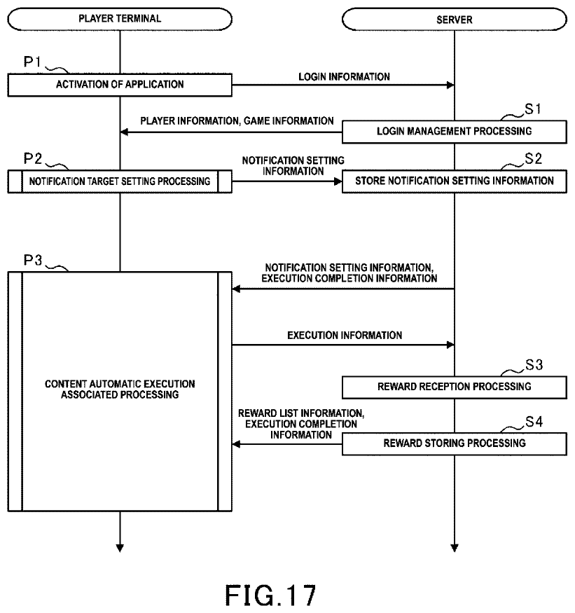

FIG. 17 is a sequence diagram for describing basic processing of the player terminal 1 and the server 1000. In the following description, the processing in the player terminal 1 is denoted by Pn (n is an arbitrary integer). Processing in the server 1000 is denoted by Sn (n is an arbitrary integer).

When the player performs a login operation such as activating a game application in the player terminal 1, the terminal-side control unit 1A transmits login information to the server 1000 (P1).

In the server 1000, when the login information is received, the server-side control unit 1000A executes login management processing of causing the player terminal 1 to receive (obtain) player information and game information stored in the server 1000 (S1).

When the player terminal 1 receives (obtains) the player information from the server 1000, the terminal-side control unit 1A stores the received player information and game information in the information storage unit 550.

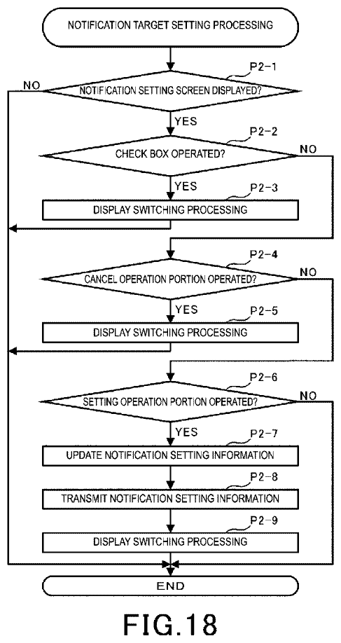

In the player terminal 1, notification target [0256] setting processing (P2) of receiving various settings for the notification function described above is executed. FIG. 18 is a flowchart for describing the notification target setting processing (P2) in the player terminal 1. As illustrated in FIG. 18, the game control unit 500a determines whether the notification setting screen 170 (FIG. 11B) is being displayed on the display 26 (P2-1).

In a case where the notification setting screen 170 is not being displayed (NO in P2-1), the game control unit 500a ends the notification target setting processing.

In a case where the notification setting screen 170 is being displayed (YES in P2-1), the game control unit 500a determines whether a player operation (tap) on the check box of the notification setting screen 170 has been detected (P2-2). In a case where a player operation (tap) on the check box of the notification setting screen 170 has been detected (YES in P2-2), the game control unit 500a executes display switching processing of highlighting the operated (tapped) check box (P2-3) and ends the notification target setting processing.

In addition, in a case where a player operation (tap) on the check box of the notification setting screen 170 has not been detected (NO in P2-2), the game control unit 500a determines whether a player operation (tap) on the cancel operation portion 173 of the notification setting screen 170 has been detected (P2-4).

In a case where a player operation (tap) on the cancel operation portion 173 of the notification setting screen 170 has been detected (YES in P2-4), the game control unit 500a executes display switching processing of ending the display of the notification setting screen 170 on the display 26 (P2-5) and ends the notification target setting processing.

In addition, in a case where a player operation (tap) on the cancel operation portion 173 of the notification setting screen 170 has not been detected (NO in P2-4), the game control unit 500a determines whether a player operation (tap) on the setting operation portion 172 of the notification setting screen 170 has been detected (P2-6).

In a case where a player operation (tap) on the setting operation portion 172 of the notification setting screen 170 has not been detected (NO in P2-6), the game control unit 500a ends the notification target setting processing.

When a player operation (tap) on the setting operation portion 172 of the notification setting screen 170 has been detected (YES in P2-6), the game control unit 500a updates the notification setting information stored in the information storage unit 550 based on the setting content displayed in the notification setting content display 171 of the notification setting screen 170 immediately before the operation (tap) is detected (P2-7).

Further, the game control unit 500a transmits the notification setting information updated in P2-7 to the server 1000 (P2-8).

In addition, the game control unit 500a executes display switching processing of displaying the schedule screen 160 on the display 26 based on the notification setting information updated in P2-7 and the execution completion information obtained in P3-3 described below and ends the notification target setting processing.

Returning to FIG. 17, when the notification setting information is received from the player terminal 1, the game control unit 1500a of the server 1000 stores the received notification setting information in the information storage unit 1550 (S2).

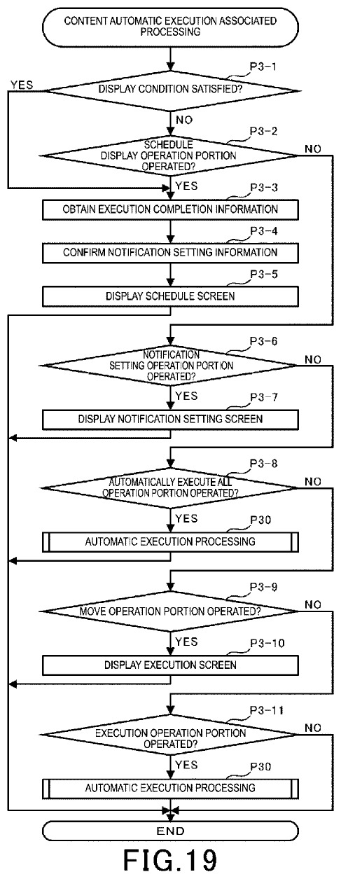

Further, as illustrated in FIG. 17, in the player terminal 1, content automatic execution associated processing (P3) is executed. FIG. 19 is a flowchart for describing the content automatic execution associated processing (P3) in the player terminal 1. As illustrated in FIG. 19, the game control unit 500a determines whether a display condition is satisfied (P3-1). Specifically, when the home screen 40 (FIG. 3) is displayed on the display 26 for the first time after the game application is activated, the game control unit 500a determines that the preset display condition is satisfied.

In a case where the display condition is satisfied (YES in P3-1), the game control unit 500a transitions the processing to P3-3 described below.

In a case where the display condition is not satisfied (NO in P3-1), the game control unit 500a determines whether the schedule screen selection operation portion 45 of the home screen 40 has been operated (tapped) by the player (P3-2). In a case where the schedule screen selection operation portion 45 has been operated (tapped) by the player (YES in P3-2), the game control unit 500a transitions the processing to P3-3 described below. In a case where the schedule screen selection operation portion 45 has not been operated (tapped) by the player (NO in P3-2), the game control unit 500a transitions the processing to P3-6 described below.

In addition, the game control unit 500a obtains the execution completion information stored in the information storage unit 1550 of the server 1000 (P3-3). The execution completion information includes information relating to whether all in-game tasks belonging to the notification system, the first execution system, the second execution system, and the third execution system described above have been executed and the number of times the in-game tasks have been executed within a preset time period (for example, from 5:00 to 4:59 the next day).

In addition, the game control unit 500a obtains the notification setting information stored in the information storage unit 1550 of the server 1000 (P3-4). However, the present invention is not limited thereto, and the game control unit 500a may obtain the notification setting information stored in the information storage unit 550 of the player terminal 1.

The game control unit 500a displays the schedule screen 160 on the display 26 based on the execution completion information obtained in P3-3 and the notification setting information obtained in P3-4 (P3-5) and ends the content automatic execution associated processing.

Note that in the present embodiment, the execution completion information obtained by the player includes but is not limited to information relating to whether all in-game tasks belonging to the notification system, the first execution system, the second execution system, and the third execution system described above have been executed and the number of times the in-game tasks have been executed within a preset time period (for example, from 5:00 to 4:59 the next day). For example, for an in-game task for which “Notify” or “Execute” is set in the notification setting information, only information regarding whether the in-game task has been executed or the number of times the in-game task has been executed within a preset time period (for example, from 5:00 to 4:59 the next day) may be obtained as the execution completion information.

That is, when displaying the schedule screen 160, the game control unit 500a checks the setting contents and the execution status of each in-game task. Then, the game control unit 500a displays the notification target display portion 162, the move operation portion 162a, the execute operation portion 162b, and the identification display 162c on the schedule screen 160 in accordance with the confirmed content.

The game control unit 500a determines whether the notification setting operation portion 161 of the schedule screen 160 has been operated (tapped) by the player (P3-6).

In a case where the notification setting operation portion 161 has been operated (tapped) by the player (YES in P3-6), the game control unit 500a displays the notification setting screen 170 on the display 26 (P3-7) and ends the content automatic execution associated processing.

In a case where the notification setting operation portion 161 has not been operated (tapped) by the player (NO in P3-6), the game control unit 500a determines whether the automatically execute all operation portion 163 of the schedule screen 160 has been operated (tapped) by the player (P3-8).

In a case where the automatically execute all operation portion 163 of the schedule screen 160 has been operated (tapped) by the player (YES in P3-8), the game control unit 500a executes automatic execution processing described below (P30) and ends the notification target setting processing.

In a case where the automatically execute all operation portion 163 of the schedule screen 160 has not been operated (tapped) by the player (NO in P3-8), the game control unit 500a determines whether the move operation portion 162a of the schedule screen 160 has been operated (tapped) by the player (P3-9).

In a case where the move operation portion 162a of the schedule screen 160 has been operated (tapped) by the player (YES in P3-9), the game control unit 500a displays the execution screen for executing the in-game task corresponding to the operated (tapped) move operation portion 162a on the display 26 (P3-10) and ends the content automatic execution associated processing.

In a case where the move operation portion 162a of the schedule screen 160 has not been operated (tapped) by the player (NO in P3-9), the game control unit 500a determines whether the execute operation portion 162b of the schedule screen 160 has been operated (tapped) by the player (P3-11).

In a case where the execute operation portion 162b of the schedule screen 160 has been operated (tapped) by the player (YES in P3-11), the game control unit 500a executes automatic execution processing described below (P30) and ends the notification target setting processing.

In a case where the execute operation portion 162b of the schedule screen 160 has not been operated (tapped) by the player (NO in P3-11), the game control unit 500a ends the notification target setting processing.

Returning to FIG. 17, when the server 1000 receives the execution information from the player terminal 1, the control game unit 1500a of the server 1000 automatically executes each in-game task to be executed based on the received execution information. Specifically, for example, processing such as spending a skip ticket, adding the number of executions, and the like are executed. In addition, in a case where an in-game task that consumes stamina is included as an execution target, processing related to subtracting stamina is executed.

Then, reward reception processing (S3) of giving a player a reward for these in-game tasks is executed.

In addition, the game control unit 1500a generates reward list information including a list of rewards given to the player in the reward reception processing (S3) and sets the reward list information to be obtained by the player terminal 1 (S4).

In addition, the game control unit 1500a generates execution completion information including information indicating that the in-game task executed in the reward reception process (S3) has been executed and sets the execution completion information to be obtainable by the player terminal 1 (S4). Specifically, the execution completion information is used to manage the number of times that the in-game tasks belonging to each execution system can be executed with respect to the limited number of times of execution.

For example, the game control unit 1500a executes processing of restricting execution of in-game tasks with “0” for the number of executable times during a time period until the number of executable times is recovered. Specifically, during the time period until the number of executable times is recovered, the corresponding in-game task may not be displayed on the notification target display portion 162.

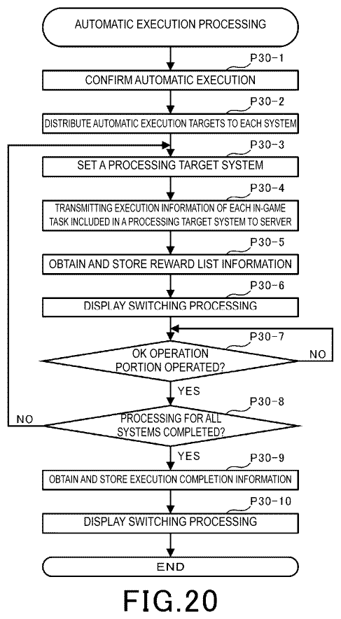

FIG. 20 is a flowchart for describing the automatic execution processing (P30) in the player terminal 1. As illustrated in FIG. 20, the game control unit 500a checks the in-game tasks to be automatically executed (P30-1). In other words, in a case where the automatically execute all operation portion 163 has been operated (tapped) by the player, all of the executable in-game tasks corresponding to the setting items set to “Execute” are set to in-game tasks to be automatically executed. On the other hand, in a case where the execute operation portion 162b has been operated (tapped) by the player, the one in-game task corresponding to the operated (tapped) execute operation portion 162b is set as an in-game task to be automatically executed.

In addition, the game control unit 500a distributes the in-game tasks to be automatically executed confirmed in P30-1 to any one of preset systems (the first execution system, the second execution system, or the third execution system) (P30-2).

The game control unit 500a sets one of the systems distributed to in P30-2 as the processing target system (P30-3).

The game control unit 500a transmits, to the server 1000, execution information for executing the in-game tasks to be automatically executed included in the system set in P30-3 (P30-4).

The game control unit 500a obtains the reward list information set in the information storage unit 1550 of the server 1000 and stores the reward list information in the information storage unit 550 of the player terminal 1 (P30-5).

Based on the reward list information obtained in P30-5, the game control unit 500a executes display switching processing of displaying a result screen corresponding to the processing target system on the display 26 (P30-6).

Specifically, in a case where the processing target system is the first execution system, the first execution system result screen 180 is displayed on the display 26 based on the reward list information. Also, in a case where the processing target system is the second execution system, the second execution system result screen 190 is displayed on the display 26 based on the reward list information. Also, in a case where the processing target system is the third execution system, the third execution system result screen 200 is displayed on the display 26 based on the reward list information.

The game control unit 500a determines whether the OK operation portion (the OK operation portion 181, the OK operation portion 191, or the OK operation portion 201) corresponding to the result screen (the first execution system result screen 180, the second execution system result screen 190, or the third execution system result screen 200) displayed in P30-6 has been operated by the player (P30-7).

In a case where the OK operation portion has been operated by the player (YES in P30-7), the game control unit 500a determines whether the processing from P30-3 to P30-7 has been executed for all of the systems distributed to in P30-2 (P30-8).

In a case where the processing has not been completed for all of the systems (NO in P30-8), the game control unit 500a transitions the processing to P30-3 and executes the processing from P30-3 to P30-7 for the unprocessed systems.

In a case where the processing has been completed for all of the systems (YES in P30-8), the game control unit 500a obtains the execution completion information set in the information storage unit 1550 of the server 1000 and stores the reward list information in the information storage unit 550 of the player terminal 1 (P30-9).

The game control unit 500a displays the schedule screen 160 (FIG. 14B) on the display 26 based on the execution completion information stored in the P30-9 and the notification setting information confirmed in P3-4 and ends the automatic execution processing.

Here, one aspect of an embodiment has been described with reference to the accompanying drawings. However, it goes without saying that the present invention is not limited to the above-described embodiment. It should be apparent that one skilled in the art can arrive at various modified examples or modified examples within the scope described in the claims, and it should be understood that the modified examples or modified examples also naturally belong in the technical scope of the present invention.

The game properties and the processing in the player terminal 1 and the server 1000 described in the above embodiment are merely examples. In any case, the information processing program causes a computer (in the embodiment, the player terminal 1 and/or the server 1000) to execute the following processing.

### Processing Executed by Computer

Processing (in the embodiment, as an example, S3) of giving a reward to a player based on execution of a first predetermined task (in the embodiment, as an example, an in-game task given as a daily mission), which is a task related to content set in advance among a plurality of pieces of content, within a predetermined time period (in the embodiment, as an example, from 5:00 to 4:59 the next day).

Processing (in the embodiment, as an example, S4) of limiting the number of times that a second predetermined task, which is a task related to preset content, can be executed within a predetermined time period.

Processing (in the embodiment, as an example, P2) of setting one of a plurality of predetermined tasks including the first predetermined task and the second predetermined task as a notification target based on a player operation.

Processing (in the embodiment, as an example, P3-5) of displaying a list display screen displaying the predetermined task designated as the notification target.

Processing (in the embodiment, as an example, P3-10) of displaying an execution screen for executing a predetermined task based on a player operation on the list display screen being displayed.

Processing (in the embodiment, as an example, P30) of omitting display of the execution screen and collectively executing a plurality of predetermined tasks based on a player operation on the list display screen being displayed.

In the embodiment described above, when automatically execute all is executed, the in-game tasks are executed for each system and the result screen is displayed, but the present invention is not limited thereto. For example, in a case where automatically execute all is executed, all the systems may be collectively executed and the result screen may be displayed. In this case, since the number of screen transitions on the display 26 can be reduced, it is possible to reduce the processing load on the player terminal 1.

In the embodiment described above, the player performs a manual operation to set each item listed in the notification setting content display 171 while not limited thereto. That is, a manual operation by the player need not be required.

For example, the game control unit 500a may automatically set each item listed in the notification setting content display 171. Alternatively, each item listed in the notification setting content display 171 may be automatically set by an Artificial Intelligence (AI) (not illustrated) installed in the player terminal 1 or the server 1000. For example, the AI may learn from the play states of the player and other players and may automatically set each item listed in the notification setting content display 171 according to the learning result.

In the embodiment described above, as an example of a game, a case has been described in which a so-called battle game is provided. However, specific contents of the game and the game genre are not limited to the embodiment described above. For example, the present invention can be applied to any game genre such as a role-playing game, a shooting game, a puzzle game, and a rhythm game.

An information processing program for executing the processing in the above-described embodiment and various modified examples may be stored in a non-transitory computer-readable storage medium and provided as a storage medium. Furthermore, a game terminal apparatus (game apparatus) including the storage medium may be provided. In addition, the above-described embodiment and various modified examples may correspond to an information processing method for implementing each function and the steps illustrated in the flowcharts.

What is claimed is:

1. A non-transitory computer readable medium storing a program causing a computer to execute:
processing of giving a reward to a player based on a first predetermined task being executed within a predetermined time period, the first predetermined task being a task related to a piece of content preset among a plurality of pieces of content provided;
processing of limiting the number of times a second predetermined task is executable within the predetermined time period, the second predetermined task being a task related to a piece of content preset among the plurality of pieces of content provided;
processing of setting any of a plurality of predetermined tasks including the first predetermined task and the second predetermined task as a notification target, based on a player operation; and
processing of displaying a list display screen displaying the any of the plurality of predetermined tasks set as the notification target.

2. The non-transitory computer readable medium according to claim 1, wherein the program further causing the computer to execute processing of displaying an execution screen for executing a predetermined task of the plurality of predetermined tasks, based on a player operation on the displayed list display screen.

3. The non-transitory computer readable medium according to claim 2, wherein the program further causing the computer to execute processing of omitting display of the execution screen and collectively executing the plurality of predetermined tasks, based on a player operation on the displayed list display screen.

4. An information processing method executed by one or more computers, the information processing method comprising:
processing, by the one or more computers, of giving a reward to a player based on a first predetermined task being executed within a predetermined time period, the first predetermined task being a task related to a piece of content preset among a plurality of pieces of content provided;
processing, by the one or more computers, of limiting the number of times a second predetermined task is executable within the predetermined time period, the second predetermined task being a task related to a piece of content preset among the plurality of pieces of content provided;
processing, by the one or more computers, of setting any of a plurality of predetermined tasks including the first predetermined task and the second predetermined task as a notification target, based on a player operation; and
processing, by the one or more computers, of displaying a list display screen displaying the any of the plurality of predetermined tasks set as the notification target.

5. A game apparatus comprising:
one or more computers, wherein
the one or more computers execute:
processing of giving a reward to a player based on a first predetermined task being executed within a predetermined time period, the first predetermined task being a task related to a piece of content preset among a plurality of pieces of content provided;
processing of limiting the number of times a second predetermined task is executable within the predetermined time period, the second predetermined task being a task related to a piece of content preset among the plurality of pieces of content provided;
processing of setting any of a plurality of predetermined tasks including the first predetermined task and the second predetermined task as a notification target, based on a player operation; and
processing of displaying a list display screen displaying the any of the plurality of predetermined tasks set as the notification target.
